(19) United States
(12) Patent Application Publication
(10) Pub. No.: US 2024/0134305 A1
(43) Pub. Date: Apr. 25, 2024

(54) FIXING APPARATUS

(71) Applicant: CANON KABUSHIKI KAISHA, Tokyo (JP)

(72) Inventors: TORU IMAIZUMI, Kanagawa (JP); TAKAAKI AKAMATSU, Kanagawa (JP); YUKI OSHIMA, Kanagawa (JP); HIROKI SASAME, Tokyo (JP)

(21) Appl. No.: 18/491,860

(22) Filed: Oct. 22, 2023

(30) Foreign Application Priority Data
Oct. 24, 2022 (JP) 2022-170440

(51) Int. Cl. G03G 15/20

(52) U.S. Cl. CPC G03G 15/2053

(57) ABSTRACT

A fixing apparatus having a first rotation member, an elongated heater having a heat generating member and a substrate on which the heat generating member is provided and being disposed in an internal space of the first rotation member, a heater holder that holds the heater, a stay that supports the heater holder, a sliding sheet being disposed between the heater and the first rotation member and sliding on an inner circumferential surface of the first rotation member, and a second rotation member forming a nip portion with the heater through the first rotation member, and, in the nip portion, a toner image formed on a recording material being heated and fixed, in which, when a longitudinal direction of a surface of the substrate on which the heat generating member is provided, a transverse direction that is orthogonal to the longitudinal direction.

### BACKGROUND OF THE INVENTION

### Field of the Invention

The present invention relates to a fixing apparatus.

### Description of the Related Art

In electrophotographic system image forming apparatuses, on-demand heating system fixing apparatuses in which a heater is used or halogen lamp heating system fixing apparatuses are known. For example, an on-demand heating system fixing apparatus has a heater having a resistance heat generating member on a ceramic substrate, a fixing film that is heated while being in contact with the heater and rotates, and a pressurizing roller that forms a nip portion with the heater through the fixing film.

In Japanese Patent Application Laid-open No. 2016-114743, in order to secure the slidability of a fixing film, a sliding sheet made of a low friction material is disposed between a heater and a fixing film inner surface.

### SUMMARY OF THE INVENTION

An objective is to develop a fixing apparatus in which a sliding sheet is used. The present invention provides a fixing apparatus comprising:
a first rotation member;
an elongated heater configured to have a heat generating member and a substrate on which the heat generating member is provided and to be disposed in an internal space of the first rotation member;
a heater holder configured to hold the heater;
a stay configured to support the heater holder;
a sliding sheet configured to be disposed between the heater and the first rotation member and to slide on an inner circumferential surface of the rotating first rotation member; and
a second rotation member configured to form a nip portion with the heater through the first rotation member, and
in the nip portion, a toner image formed on a recording material being heated and fixed,
wherein, when a longitudinal direction of a surface of the substrate on which the heat generating member is provided, a transverse direction that is orthogonal to the longitudinal direction, and a thickness direction that is orthogonal to the longitudinal direction and the transverse direction are designated, the heater holder has a first side configured to hold the heater and a second side opposite to the first side in the thickness direction, and
the sliding sheet is sandwiched by the second side and the stay.

It is possible to develop a fixing apparatus in which a sliding sheet is used.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus of Example 1;

FIG. 2 is a cross-sectional view of a central portion of a fixing apparatus of Example 1 in a longitudinal direction;

FIG. 3 is a cross-sectional view of the fixing apparatus of Example 1 in the longitudinal direction;

FIG. 4A to FIG. 4C are views for describing a method for mounting a sliding sheet of Example 1;

FIG. 5A and FIG. 5B are views for describing a modification example of Example 1;

FIG. 6A and FIG. 6B are schematic views of a method for mounting a sliding sheet of Comparative Example 1;

FIG. 7A and FIG. 7B are schematic views of a method for mounting a sliding sheet of Comparative Example 2;

FIG. 8A and FIG. 8B are cross-sectional views of a fixing apparatus of Example 2;

FIG. 9 is a cross-sectional view for describing an effect of Example 2;

FIG. 10A and FIG. 10B are cross-sectional views of a fixing apparatus of Example 3;

FIG. 11 is a schematic view of a sliding sheet of Example 3;

FIG. 12A and FIG. 12B are schematic views of the configuration of a fixing apparatus of Example 4;

FIG. 13 is a schematic view of the configuration of a fixing apparatus of Example 5;

FIG. 14A and FIG. 14B are views showing a modification example of Example 4;

FIG. 15 is a cross-sectional view showing a modification example of Example 4;

FIG. 16 is a cross-sectional view showing a modification example of Example 4;

FIG. 17A to FIG. 17C are schematic views of the configuration of a fixing apparatus of Example 6;

FIG. 18 is a cross-sectional view of the configuration of a fixing apparatus of Example 7;

FIG. 19A and FIG. 19B are schematic views of a sliding sheet of the fixing apparatus of Example 7;

FIG. 20 is a cross-sectional view of a fixing apparatus of a modification example;

FIG. 21 is a cross-sectional view of a fixing apparatus of Example 8;

FIG. 22 is a view for describing the position of a heater holder at the time of feeding large-sized paper of Example 8;

FIG. 23 is a view for describing the position of the heater holder at the time of feeding small-sized paper of Example 8;

FIG. 24 is a view for describing the characteristics of a sliding sheet of Example 8;

FIG. 25 is a view for describing the characteristics of the sliding sheet of Example 8;

FIG. 26 is a view for describing the characteristics of a sliding sheet of Comparative Example 1;

FIG. 27A and FIG. 27B are views for describing the characteristics of the sliding sheet of Comparative Example 1;

FIG. 28 is a view for describing the characteristics of a sliding sheet of Comparative Example 2;

FIG. 29A and FIG. 29B are views for describing the characteristics of the sliding sheet of Comparative Example 2;

FIG. 30A and FIG. 30B are views for describing the effect of an example;

FIG. 31 is a view for describing the characteristics of a sliding sheet of a modification example;

FIG. 32 is a view for describing the characteristics of the sliding sheet of the modification example;

FIG. 33 is a view for describing the characteristics of a sliding sheet of Example 9;

FIG. 34 is a view for describing the characteristics of the sliding sheet of Example 9;

FIG. 35 is a cross-sectional view of a fixing apparatus of Example 10;

FIG. 36 is a view for describing the characteristics of a sliding sheet of Example 11;

FIG. 37 is a cross-sectional view of a central portion of a fixing apparatus of Example 11 in the longitudinal direction;

FIG. 38 is a cross-sectional view of an end portion of the fixing apparatus of Example 11 in the longitudinal direction;

FIG. 39 is a view for describing the disposition of the sliding sheet of Example 11;

FIG. 40 is a view for describing the characteristics of the sliding sheet of Comparative Example 1;

FIG. 41 is a view for describing the disposition of the sliding sheet of Comparative Example 1;

FIG. 42 is a view for describing the disposition of the sliding sheet of Comparative Example 2; and

FIG. 43 is a view for describing an evaluation image pattern of Example 11.

### DESCRIPTION OF THE EMBODIMENTS

Hereinafter, an embodiment of the present invention will be described in detail with reference to drawings. Here, the dimensions, materials, or shapes of configuration components that are described in the embodiment, relative disposition thereof, and the like should be modified as appropriate depending on the configuration of an apparatus to which the invention is applied, a variety of conditions, and the like, and there is no intention to limit the scope of this invention to the following embodiment.

(I)

In order to secure the slidability of a fixing film, in a fixing apparatus in which a sliding sheet made of a low friction material is disposed between a heater and a fixing film inner surface, there are cases where the friction coefficient between the fixing film and the sliding sheet increases due to a factor such as a durability test. In this case, when a pressurizing roller has been driven, a large force is exerted on the sliding sheet downstream in a conveyance direction in a nip portion. As a result, a force is locally applied to the circumference of a hole portion hung on a projecting portion of a nip-forming member, and thus a wrinkle is generated in the sliding sheet. Consequently, there is a concern that uneven heat transmission from the heater to the fixing film in a fixing nip or an uneven pressure distribution on the surface of a recording material at the time of feeding paper may be caused and it may become impossible to obtain uniform fixing performance. Therefore, in a fixing apparatus in which a sliding sheet is used to secure the slidability of a fixing film, there is a need to hold the sliding sheet in a favorable state.

### Example 1

### Image Forming Apparatus

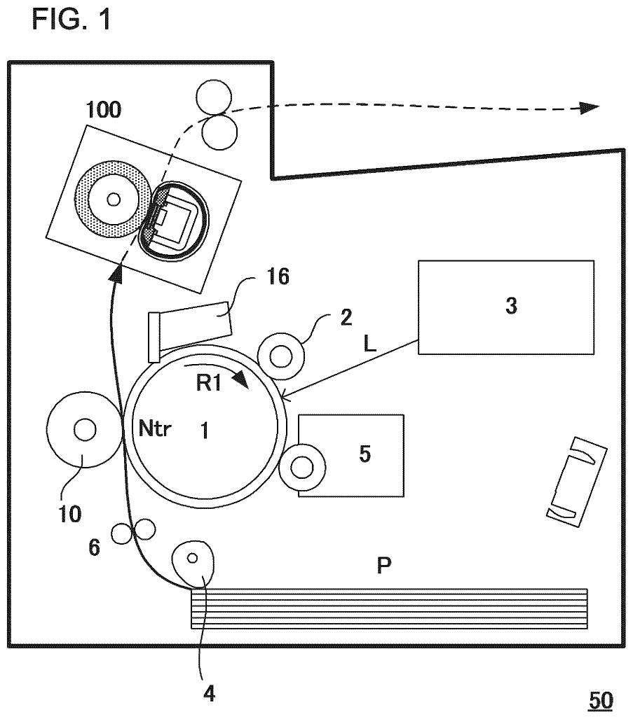

An example of an image forming apparatus of the present example will be described using a cross-sectional view shown in FIG. 1. An image forming apparatus 50 in the present example is an electrophotographic system image forming apparatus in which a toner image on a photosensitive drum 1 is directly transferred onto a recording material P. On the circumferential surface of the photosensitive drum 1, which is an image bearing member, a charging unit 2, an exposing apparatus 3 that irradiates the photosensitive drum 1 with laser light L, a developing unit 5, a transfer roller 10, and a photosensitive drum cleaner 16 are disposed in order along a rotation direction (arrow R1 direction).

The charging unit 2 charges the surface of the photosensitive drum 1 to a negative polarity. The exposing apparatus 3 irradiates the charged surface of the photosensitive drum 1 with laser light L. Since the surface potential increases in an exposed part, an electrostatic latent image is formed on the surface of the photosensitive drum 1. A toner of the present example has been charged to a negative polarity. The developing unit 5 containing the toner attaches the negative toner only to the electrostatic latent image portion on the photosensitive drum 1. Therefore, a toner image T is formed on the photosensitive drum 1.

A sheet feeding roller 4 picks up and feeds the recording material P. A conveying roller 6 conveys the recording material P up to a transfer nip Ntr. When a transfer bias with a positive polarity, which is a reverse polarity with respect to the polarity of the toner, is applied to the transfer roller 10 from a power supply, which is not shown, the toner image T on the photosensitive drum 1 is transferred onto the recording material P in the transfer nip Ntr. The photosensitive drum cleaner 16 having an elastic blade removes untransferred toner from the surface of the photosensitive drum 1 after the transfer. A fixing apparatus 100 heats and fixes the toner image T on the surface of the recording material P.

Fixing Apparatus

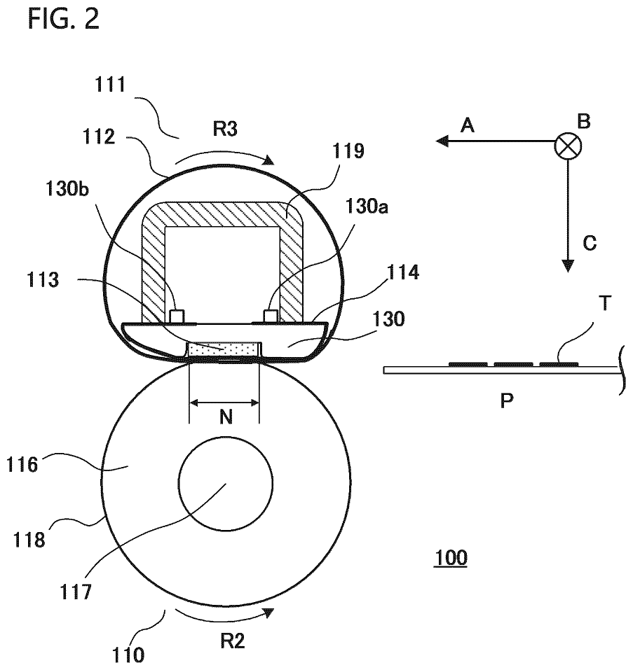

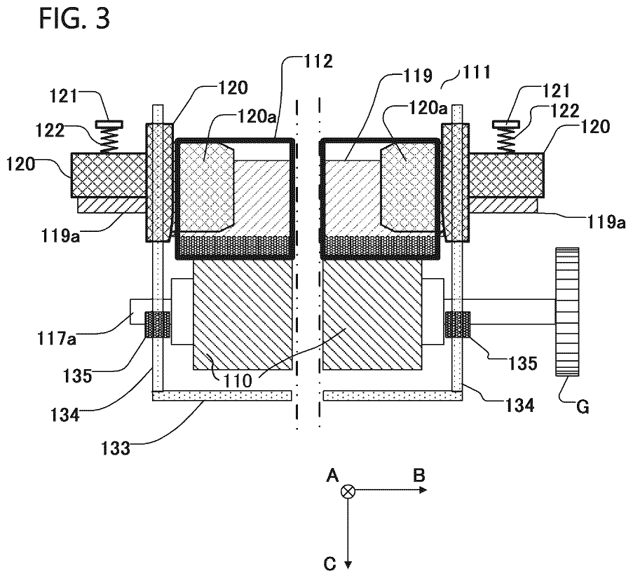

The fixing apparatus 100 of the present example is an on-demand heating system fixing apparatus intended to shorten the rise time or reduce power consumption. FIG. 2 is a cross-sectional view of the vicinity of a longitudinal central portion of the fixing apparatus 100. FIG. 3 is a cross-sectional view in the longitudinal direction, and the middle portion omitted is indicated by dashed-two dotted lines. In the following description, a recording material conveyance direction is indicated by A, the longitudinal direction is indicated by B, and a heater sliding surface perpendicular direction is indicated by C.

A heater 113 is a heating member. A heater holder 130 as a holding member holds the heater 113. A sliding sheet 114 having excellent lubricity and heat resistance is in contact with the surface of the heater 113. A fixing film 112 as a first rotation member, which is a cylindrical belt as an endless film, is provided around the sliding sheet 114. The heater 113 heats the fixing film 112 through the sliding sheet 114. The sliding sheet 114 is disposed between the heater 113 and the fixing film 112 and slides on the inner circumferential surface of the rotating fixing film 112.

A pressurizing roller 110 as a second rotation member pressurizes the heater 113 through the sliding sheet 114 from the outside of the fixing film 112. A region where the pressurizing roller 110 and the fixing film 112 are in contact with each other due to pressurization is designated as a fixing nip N as a nip portion. When the pressurizing roller 110 is driven in an arrow R2 direction in the drawing, the fixing film 112 receives power from the pressurizing roller 110 in the fixing nip N and is driven to rotate in an arrow R3 direction. When the recording material P to which the unfixed toner image T has been transferred is moved in the recording material conveyance direction A, which is indicated by an arrow in the drawing, and conveyed to the fixing nip N, the toner image T is fixed to the recording material P.

The fixing film 112 of the present example has an inner diameter of 118 mm in a state of an unmodified cylindrical shape. The fixing film 112 has a multilayer configuration in the thickness direction. The multilayer configuration of the fixing film 112 is composed of a base layer for maintaining the strength of the film and a releasing layer for reducing the attachment of dirt to the surface.

The material of the base layer needs to be heat-resistant in order to receive heat from the heater 113 and also needs to have a strength to slide on the sliding sheet 114, and thus a metal such as stainless steel or nickel or a heat-resistant resin such as a polyimide is preferably used. In the present example, a polyimide resin was used as the material of the base layer of the fixing film 112, and the resin was used after a carbon filler was added thereto in order to improve the heat conductivity and the strength. As the thickness of the base layer becomes thinner, it becomes easier to transmit heat on the inner surface of the fixing film 112 toward the surface of the pressurizing roller 110, but the strength decreases, and thus the thickness is preferably approximately 15 μm to 100 μm and was set to 60 μm in the present example.

As the material of the releasing layer in the fixing film 112, fluororesins such as a perfluoroalkoxy resin (PFA), a polytetrafluoroethylene resin (PTFE) or a tetrafluoroethylene-hexafluoropropylene resin (FEP) are preferably used. In the present example, among the fluororesins, PFA having excellent releasability and heat resistance was used. The releasing layer may be a layer covered with a tube or a layer having a surface coated with paint. In the present example, the releasing layer was molded by coating, which is excellent in terms of thin molding. As the releasing layer becomes thinner, it becomes easier to transmit heat on the inner surface of the fixing film 112 to the surface of the fixing film 112; however, when the releasing layer is too thin, the durability deteriorates, and thus the thickness is preferably approximately 5 μm to 30 μm and was set to 15 μm in the present example. In addition, an elastic layer may be provided between the base layer and the releasing layer while not used in the present example. In that case, as the material of the elastic layer, silicone rubber, fluorocarbon rubber, or the like is used.

The heater holder 130 is provided on the inside of the fixing film 112. The heater holder 130 is a gutter having a substantially semi-circular cross section and is formed of a highly heat-resistant liquid crystalline polymer resin to satisfy heat resistance and stiffness. In the present example, SUMIKASUPER (registered trademark) manufactured by Sumitomo Chemical Co., Ltd. is used as the liquid crystalline polymer resin. In addition, the heater holder 130 also has a function of guiding the rotation of the loosely-fitted fixing film 112 in addition to the function of holding the heater 113.

The sliding sheet 114 is provided on the outer circumference of the heater holder 130 and the heater 113. The material of the sliding sheet 114 is desirably heat-resistant and has favorable slidability. For example, a rectangular sheet-like member obtained by knitting fibers made of a resin such as PTFE or PFA can be used. The sliding sheet 114 is not limited to this shape, and, for example, a sheet obtained by coating a base material with a substance having favorable slidability may also be used. When the fixing film 112 rotates, the sliding sheet 114 and the fixing film 112 slide on each other, which makes torque that drives the fixing film 112 reduced, and thus a load on the fixing film 112 is decreased.

The fixing film 112 tends to return to a truly circular shape due to its own stiffness. Therefore, upstream and downstream of the fixing nip N, the inner surface of the fixing film 112 is pressed with a certain degree of force in a direction toward the heater holder 130 due to the restoring force of the fixing film 112 itself. In a case where there is no sliding sheet, the fixing film 112 and the heater holder 130 slide on each other, and thus there is a concern that the sliding resistance may increase.

A pressurizing stay 119 (stay) as a pressurizing member is disposed along the longitudinal direction of the heater holder 130. The pressurizing stay 119 is configured by bending a highly stiff metal plate of iron, stainless steel or the like in order to uniformly pressurize the heater holder 130 in the longitudinal direction.

As shown in FIG. 3, fixing flanges 120 are fitted into right and left outward extension arm portions 119a of the pressurizing stay 119, respectively. A film unit 111 is arranged substantially parallel to the upper side of the pressurizing roller 110 with the heater 113 facing downward and is disposed between right and left side-plates 134 of an apparatus frame 133. A core metal axis portion 117a of the pressurizing roller 110 is installed on a bearing member 135 engaged with the right and left side-plates 134 of the apparatus frame 133. Vertical groove portions that are provided in the right and left fixing flanges 120, respectively, are engaged with vertical edge portions of vertical guide slits provided in the right and left side-plate 134, respectively. In addition, a pressurizing spring 122 is provided between each of the right and left fixing flanges 120 and a pressurizing spring supporting unit 121. Therefore, a pressing force is transmitted to the heater 113 through the right and left fixing flanges 120, the pressurizing stay 119, and the heater holder 130. As a result, the heater 113 is pressurized against the upper surface of the pressurizing roller 110 by a predetermined pressing force (14 kgf in the present example) with the sliding sheet 114 and the fixing film 112 therebetween.

The pressurizing roller 110 of the present example has an outer diameter of Φ20 mm and has a 3.5 mm-thick elastic layer 116 formed on the circumference of an iron core metal 117 having Φ13 mm. As the material of the elastic layer 116, solid rubber or foam rubber is used. Foam rubber has a low heat capacity and a low thermal conductivity, which makes it difficult for heat on the surface of the pressurizing roller 110 to be absorbed into the foam rubber, and thus has an advantage in that the surface temperature is likely to increase and the fixing rise time can be shortened. In the present example, foam rubber obtained by foaming silicon rubber was used.

When the outer diameter of the pressurizing roller 110 is small, the heat capacity is suppressed; however, when the outer diameter is too small, the width of the fixing nip N becomes narrow, and thus the diameter needs to be appropriate. In the present example, the outer diameter was set to Φ20 mm. On the elastic layer 116, a releasing layer 118 made of perfluoroalkoxy resin (PFA) is formed as a releasing layer of the toner. The releasing layer 118 may be, similar to the releasing layer of the fixing film 112, a layer covered with a tube or a layer having a surface coated with paint. In the present example, a tube having excellent durability was used. As the material of the releasing layer 118, aside from PFA, fluororesins such as PTFE and FEP, fluorocarbon rubber or silicone rubber having favorable releasability, and the like may be used. As the surface hardness of the pressurizing roller 110 becomes lower, the width of the fixing nip N can be obtained with a lighter pressure. In the present example, a pressurizing roller having an Asker C hardness (4.9 N load) of 50° was used. In the present example, the width of the fixing nip N in the recording material conveyance direction is approximately 6.0 mm in the longitudinal direction.

The heater 113 of the present example is an ordinary heater that is used in on-demand heating system fixing apparatuses and has a configuration in which a resistance heat generating member as a heat generating member is provided on a ceramic substrate as a base material. That is, the heater 113 of the present example is an elongated heater having a heat generating member and a substrate on which the heat generating member is provided and being disposed in the internal space of the fixing film 112 as a first rotation member. The elongated heater 113 has a longitudinal direction and a transverse direction that is orthogonal to the longitudinal direction on a surface on which the heat generating member of the substrate is provided. The heater 113 has a thickness direction that is orthogonal to the longitudinal direction and the transverse direction. As the heater 113, a heater obtained by applying an Ag/Pd (silver palladium) resistance heat generating member on a surface of an alumina substrate that is 6 mm in width in the recording material conveyance direction and 1 mm in thickness by screen printing in a thickness of approximately 10 μm and covering the resistance heat generating member with 50 μm-thick glass for heat generating member protection and insulating property securement was used. In addition, the temperature of the heater 113 is adjusted by controlling a current that flows through the resistance heat generating member as appropriate depending on signals of a temperature detection element, not shown, that detects the temperature of the fixing film 112. The heater 113 is fixed and supported by being fitted into a groove portion provided in the heater holder 130. When the heater holder 130 holds the heater 113, a surface on which the heater holder 130 holds the heater 113 is designated as a first side, and a surface opposite to the first side in the thickness direction is designated as a second side. In the present example, in order to efficiently transmit heat to the recording material P, the center of the heater 113 and the center of the pressurizing roller 110 are matched in the recording material conveyance direction.

When a rotational force is transmitted from a driving mechanism portion, not shown, to a driving gear G of the pressurizing roller 110, the pressurizing roller 110 is driven to rotate at a predetermined rate in the arrow R2 direction. This driven rotation of the pressurizing roller 110 makes the rotational force exerted on the fixing film 112 due to a friction force between the pressurizing roller 110 and the fixing film 112 in the fixing nip N. Therefore, the fixing film 112 rotates following the pressurizing roller 110. At this time, the outer circumference of the heater holder 130 is rotated in the arrow R3 direction while the inner surface of the fixing film 112 stays in close contact with the lower surface of the heater 113 and slides thereon. The surface movement rate in the present example is 200 mm/sec.

In a case where the fixing nip N is formed between the pressurizing roller 110 and the heater holder 130 through the fixing film 112 by shifting the center of the heater 113 upstream or downstream in the conveyance direction of the recording material P, the heater holder 130 and the fixing film 112 strongly rub against each other, which makes it more likely for the sliding resistance to increase. However, in the present example, since the sliding sheet 114 is provided so as to cover the heater holder 130, an increase in the sliding resistance is suppressed even in a case where the center of the heater 113 is shifted upstream or downstream in the conveyance direction of the recording material P.

Sliding Sheet

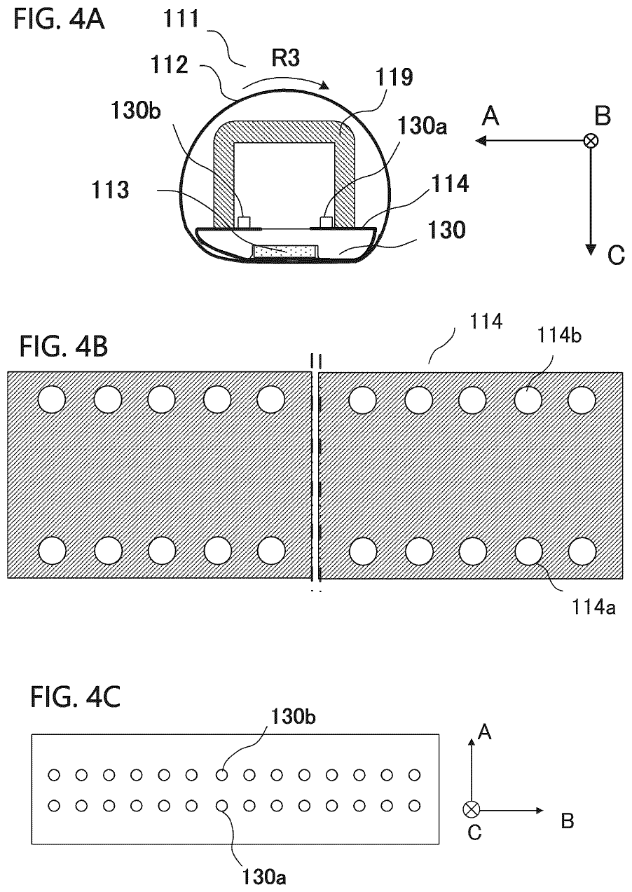

Next, a holding configuration of the sliding sheet, which is a characteristic configuration of the present invention, will be described. As shown in FIG. 4A, the sliding sheet 114 is mounted so as to cover the entire region of the pressurizing roller-side surfaces of the heater 113 and the heater holder 130. The sliding sheet 114 is a sheet-like member having an elongated rectangular shape. As shown in FIG. 4B, in the sliding sheet 114 before being mounted, opening portions 114a and 114b for mounting are provided at a plurality of places along the longitudinal direction in the vicinities of the end portions in the transverse direction. In the drawing, the longitudinal-direction middle portion omitted is indicated by dashed-two dotted lines.

As shown in FIG. 4C, the heater holder 130 includes convex portions 130a and 130b at a plurality of places along the longitudinal direction on a surface opposite to the surface on which the heater 113 is held as mounting portions for mounting the sliding sheet 114. The sliding sheet 114 is mounted so as to cover the heater holder along the curved surface of the heater holder 130 on which the heater 113 has been mounted, and the convex portions 130a and 130b are inserted into the opening portions 114a and 114b at both widthwise ends. After that, the pressurizing stay 119 is mounted, whereby the sliding sheet 114 is put into a state of being sandwiched between the pressurizing stay 119 and the heater holder 130 along the longitudinal direction. After that, the film unit 111 is combined into the fixing apparatus, and a pressurizing force of the fixing apparatus is applied through the pressurizing stay 119. At that time, the sliding sheet 114 is in a state of being pressurized and sandwiched by the pressurizing stay 119 and the heater holder 130 and is thus fixed with a substantially uniform pressure due to the pressurizing force of the fixing apparatus. Regarding the substantially uniform pressure, a pressure at each position in the longitudinal direction needs to be uniform enough to prevent the generation of a wrinkle or the like.

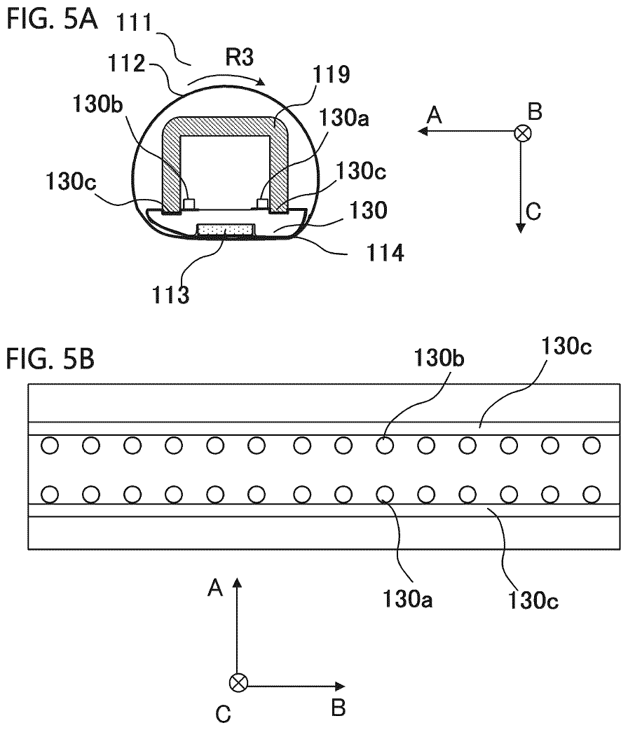

Contact regions of the heater holder 130 with the pressurizing stay 119 may be provided with a planar shape as shown in FIG. 4A to FIG. 4C. In addition, as shown in a modification example of FIG. 5A and FIG. 5B, step portions 130c may be provided on the heater holder 130 in order to assist the fixation of the pressurizing stay 119. The steps provided make it possible for the sliding sheet 114 to be mounted in a bent state, and an effect of fastening the sliding sheet 114 between the pressurizing stay 119 and the heater holder 130 is further enhanced.

It is also possible to use a lubricant to reduce friction between the sliding sheet 114 and the inner circumferential surface of the fixing film 112. The lubricant is desirably a lubricant that is heat-resistant and capable of maintaining the lubrication performance for a long period of time such as silicon oil, silicon grease, or fluorine grease. In the present example, a fluorine-based grease was used as the lubricant. Specifically, a grease obtained by mixing a polytetrafluoroethylene (PTFE) powder as a thickener with perfluoropolyether (PFPE) oil used as base oil was used. 250 mg of the grease was applied by spray coating 210 mm that was slightly shorter than 220 mm, which was the width of a pressurization region of the pressurizing roller 110 in the longitudinal direction on the heater sliding surface S.

As described above, in the present example, in the mounting of the sliding sheet 114, the opening portions 114a and 114b of the sliding sheet 114 are mounted on the convex portions 130a and 130b on the rear surface (the surface opposite to the side on which the heater is provided) of the heater holder 130. In addition, the sliding sheet 114 is sandwiched between the pressurizing stay 119 and the heater holder 130 with a substantially uniform pressure in the longitudinal direction due to the pressure that is applied from the pressurizing stay 119. At that time, positions where the pressure from the pressurizing stay 119 is received in the sliding sheet 114 (portion to be pressurized) are preferably between, regarding the opening portions 114a, the positions where the opening portion 114a is mounted on the convex portion 130a and the position where the sliding sheet 114 faces the fixing nip N. Similarly, regarding the opening portions 114b, the positions to be pressurized are between the positions where the opening portion 114b is mounted on the convex portion 130b and the position where the sliding sheet 114 faces the fixing nip N.

Effect

In the present example, the opening portions 114a and 114b of the sliding sheet 114 are mounted on the convex portions 130a and 130b on the rear surface of the heater holder 130. In addition, the sliding sheet is sandwiched due to the pressurizing force of the fixing apparatus that is applied from the pressurizing stay 119 at positions closer to the fixing nip than the opening portions 114a and 114b on the circumference of the sliding sheet in the sliding direction of the pressurizing roller 110 and the sliding sheet 114. Here, when the surface on which the heater holder 130 holds the heater 113 is designated as the first side, and the surface opposite to the first side in the thickness direction is designated as the second side as described above, the sliding sheet 114 is sandwiched by the second side of the heater holder 130 and the pressurizing stay 119.

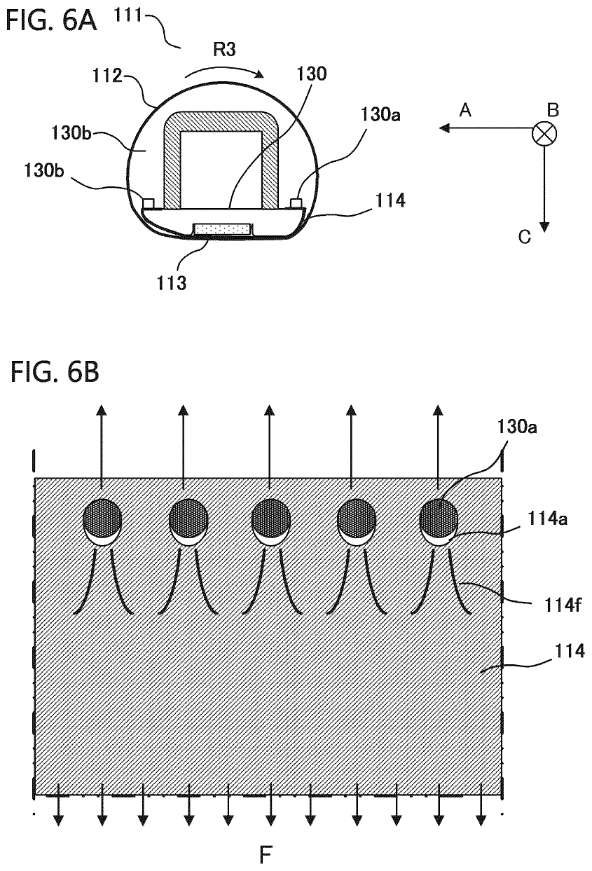

FIG. 6A showed an example where the mounting position or fixation method of the sliding sheet 114 is different from that of the present example as Comparative Example 1. That is, in Comparative Example 1, the sliding sheet 114 is mounted only by inserting the convex portions 130a on the heater holder 130 into the opening portions 114a and 114b. As shown in the drawing, the pressing force of the pressurizing stay 119 is not applied to the sliding sheet 114.

In Comparative Example 1, the sliding sheet 114 receives a friction force due to sliding on the inner surface of the fixing film 112 and receives a force that is exerted from the upstream side toward the downstream side in the conveyance direction in the fixing nip. FIG. 6B shows the appearance of the sliding sheet 114 on the upstream side (the right side in the drawing) in a case where a longitudinal uniform force F has been applied to the sliding sheet 114. The sliding sheet 114 is pulled downstream in the conveyance direction, whereby the opening portions 114a collide with the convex portions 130a of the heater holder 130 and receive a force. Therefore, the sliding sheet receives a nonuniform force in the longitudinal direction at the mounting portions. As a result, depending on the stiffness of the sliding sheet, there are cases where wrinkles 114f are generated in the sliding sheet 114 as shown in FIG. 6B. When wrinkles are generated in the sliding sheet 114 and the wrinkles affect the fixing nip N, there is a possibility that heat transmission may be impaired and a fixing defect may be generated. Alternatively, there is a concern that a place where the pressurizing force is locally strong may be generated in the sliding portion and may adversely affect durability.

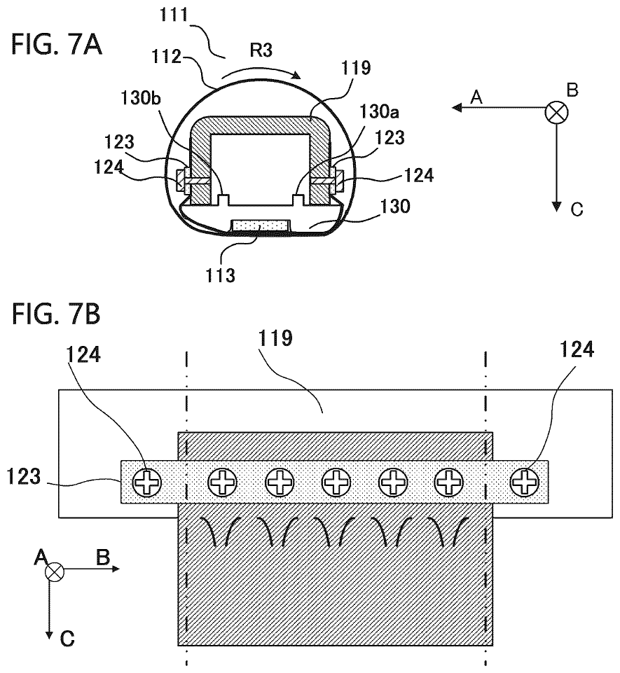

Next, FIG. 7A shows an example where the sliding sheet 114 is fixed to the pressurizing stay 119 with planar metal plates 123 and screws 124 as fastening members as Comparative Example 2. The metal plates 123 are fastened to the pressurizing stay 119 with the screws 124 at places corresponding to the opening portions 114a of the sliding sheet 114 and both ends in the longitudinal direction.

In FIG. 7A, the sliding sheet 114 is fixed with the metal plates 123. However, depending on the mounting accuracy, there is a concern that a wrinkle may be generated in the sheet. In addition, the sliding sheet 114 is fixed through the metal plates 123, but is restrained with a strong force at the fastening portions with the screws 124 and restrained with a weak force at a place therebetween. This generates an uneven pressure distribution in the longitudinal direction and causes the generation of a wrinkle in the sliding sheet 114. In addition, the use of an elastic body such as a leaf spring instead of the metal plate 123 can also be considered, but this makes it difficult to generate a longitudinal uniform pressurizing force, and thus there is a concern that a wrinkle may be generated in the sliding sheet 114 depending on a variation in the elastic body.

Incidentally, in the present example, since the sliding sheet 114 is pressurized and sandwiched with a substantially uniform pressure along the longitudinal direction, it is possible to reduce the generation of a wrinkle in the sliding sheet 114.

That is, in the configuration of the present example, when the sliding sheet 114 has been strongly pulled in the conveyance direction by a friction force that is generated in the nip N, the force is weakened by the portions in the sliding sheet 114 that are pressurized and sandwiched with the pressurizing stay 119 (portions to be pressurized). In addition, finally, the movement of the sliding sheet 114 is regulated by the mounting portions of the sliding sheet 114 (the portions where the opening portions 114a are fixed to the convex portions 130a). At this time, in the portions to be pressurized of the sliding sheet 114, since a pressure that is substantially uniform in the longitudinal direction is applied by the pressurizing force for forming the nip N of the fixing apparatus in the thickness direction of the sliding sheet 114, there is no degree of freedom for the sliding sheet 114 to deform in the thickness direction. Therefore, even when wrinkles have been somewhat generated in the vicinities of the mounting portions of the sliding sheet, the sliding sheet 114 receives a pressure attributed to the pressurizing stay 119 in the portions to be pressurized of the sliding sheet 114, whereby it is possible to reduce the generation of wrinkles at positions closer to the fixing nip N than the portions to be pressurized.

In addition, the pressurizing stay 119 may be configured to be capable of releasing or relieving the pressure. In that case, as a pressure release operation, for example, a method in which the positions of the pressurizing spring supporting units 121 are pushed up by rotating a cam, not shown, and the pressurizing force is relieved may be employed. In a case where the pressure has been released, the pressurizing force between the pressurizing stay 119 and the heater holder 130 is relieved. At that time, the force by which the sliding sheet 114 has been pressurized and sandwiched is also relieved, and thus a wrinkle in the sliding sheet 114 is also relieved accordingly. What is necessary for the pressure release is not to completely separate the fixing film 112 and the pressurizing roller 110 simply but to weaken the pressurizing force. That is, pressure releasing mentioned in the present invention refers to the adjustment of a pressure that decreases the pressure.

As described above, in the present example, it is possible to hold the sliding sheet 114 while reducing a wrinkle that is generated in the sliding sheet 114 with a relatively simple configuration.

In order to assist the fixation of the sliding sheet 114, double sided tape or the like may be used between the heater holder 130 and the sliding sheet 114. In addition, a slip prevention process or a slip prevention treatment may be performed on a portion where the heater holder 130 comes into contact with the sliding sheet 114.

### Example 2

In Example 2, only the shape of an upstream portion of the heater holder 130 relative to the fixing nip N is different from that in Example 1. Other configurations are the same as in Example 1 and will thus not be described.

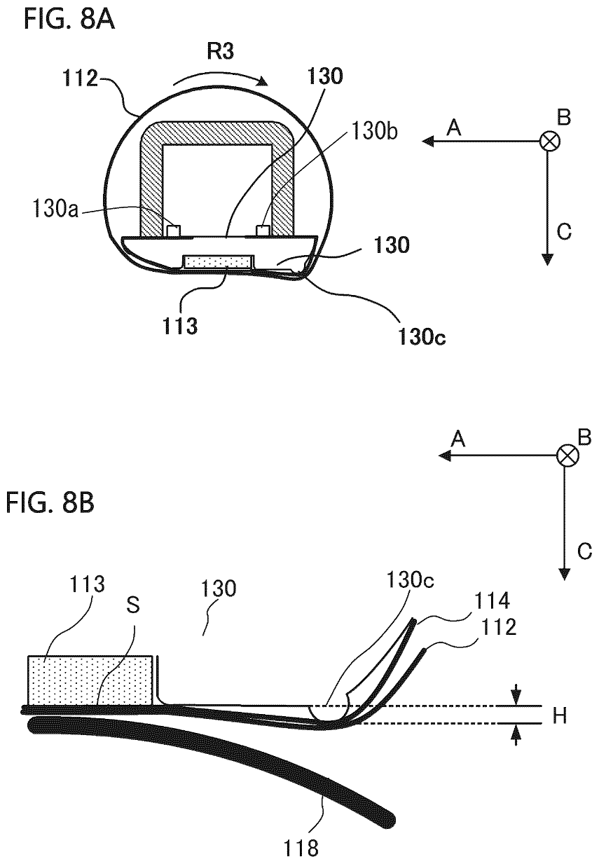

In the present example, as shown in FIG. 8A and FIG. 8B, in the heater holder 130, the shape of the upstream portion of the fixing nip N includes an upstream side protrusion portion 130d that protrudes toward the pressurizing roller 110 more than the heater sliding surface. A protrusion height H of the upstream side protrusion portion 130d from the heater sliding surface S needs to be a certain degree of height in order to regulate the trajectory of the sliding sheet 114 and obtain an effect of the present example; however, when the protrusion height is too high, the entrance of the recording material P into the fixing nip is hindered, and thus a height of approximately 0.1 to 2.0 is desirable. In the present example, the height H from the heater sliding surface S of the top portion of the protrusion portion 130d is set to 0.5 mm.

Effect

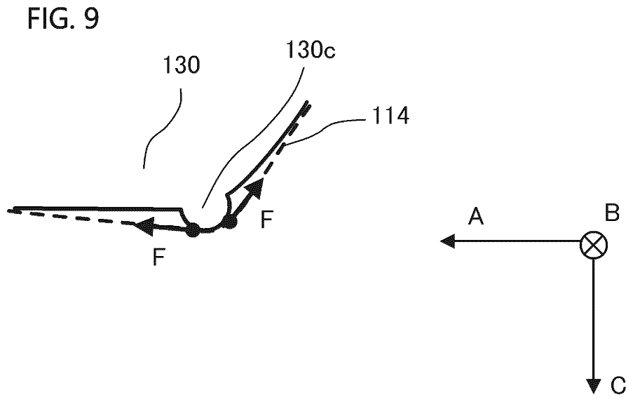

Next, the action and effect of the fixing apparatus in the present example will be described. In the present example, the protrusion portion 130d protrudes relative to the heater sliding surface S. Therefore, as shown in FIG. 9, when the sliding sheet 114 has received a force being exerted downstream in the conveyance direction in the fixing nip N, at the protrusion portion 130d, a force F works such that the sliding sheet 114 is pressed against the protrusion portion 130d due to tension. Therefore, the shape of the sliding sheet 114 is followed at the protrusion portion 130d. As a result, even when wrinkles have been generated in the sliding sheet 114 at the mounting portions, the shapes of the wrinkles do not propagate up to the fixing nip N, and thus it is possible to stabilize the shape of the sliding sheet 114 between the protrusion portion 130d and the fixing nip N.

### Example 3

In Example 3, the present invention was applied to a fixing apparatus in which a halogen heater was used as a heat source. Configurations other than a film unit 111 are the same as in Example 1 and will thus not be described in detail.

Characteristics

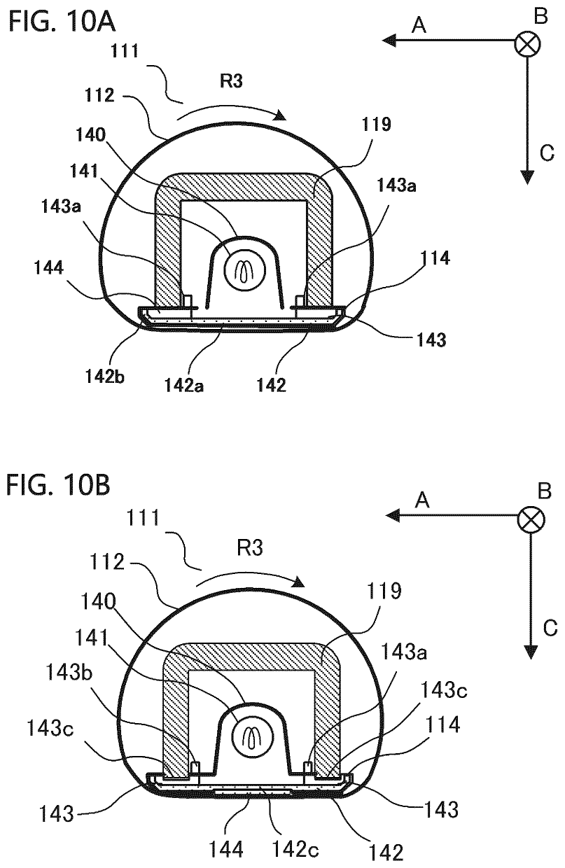

As shown in FIG. 10A, the film unit 111 of the present example includes a pressurizing stay 119, a reflecting plate 140, a halogen lamp 141 as a heating source, a nip plate 142 as a nip-forming member, a sliding sheet 114, and a fixing film 112.

The pressurizing stay 119 is a member that, similar to the above-described example, extends in the longitudinal direction, has high stiffness, and has a substantially square tube shape that is open toward the pressurizing roller 110, which is a pressurizing member. The fixing film 112 has, similar to the above-described example, a cylindrical shape that extends in the longitudinal direction, and the inner surface is in contact with the surface of the sliding sheet 114. Similar to the above-described example, it is preferable to use a lubricant for reducing friction during sliding between the sliding sheet 114 and the inner circumferential surface of the fixing film 112.

The reflecting plate 140 is disposed inside of the pressurizing stay 119. The reflecting plate 140 is made of a metal, extends in the longitudinal direction, and has a substantially square tube shape that is open toward the pressurizing roller 110. The inner surface of the reflecting plate 140 has been mirror-finished.

The halogen lamp 141 is disposed inside of the reflecting plate 140. The halogen lamp 141 is disposed along the longitudinal direction. The position or number of the halogen lamp 141 is determined as appropriate depending on the apparatus configuration or desired performance. The both longitudinal end portions of the reflecting plate 140 or the halogen lamp 141 are each supported by a cover, not shown. The nip plate 142 is disposed on the pressurizing roller 110 side of the halogen lamp 141. The nip plate 142 is disposed so as to surround the halogen lamp 141 and the reflecting plate 140 together with the pressurizing stay 119. The nip plate 142 is a member having a substantially flat plate shape that extends in the longitudinal direction and is intended to receive radiant heat from the halogen lamp 141 and is in contact with the sliding sheet 114, which slides on the inner circumference of the fixing film 112. The nip plate 142 transmits the radiant heat received from the halogen lamp 141 to the toner image T on the recording material P through the sliding sheet 114 and the fixing film 112. The nip plate 142 is formed of a member having a large heat conductivity, for example, an aluminum plate or the like. The side of the nip plate 142 facing the halogen lamp 141 is painted black to increase the efficiency of absorbing radiant heat. The nip plate 142 has a flat portion 142a and a curved portion 142b. The curved portion 142b extends upstream and downstream in the conveyance direction of the flat portion 142a and is curved toward the pressurizing stay 119.

Nip plate holding members 143 and 144 are disposed between the pressurizing stay 119 and the nip plate 142. The nip plate holding members 143 and 144 are formed of a highly heat-resistant liquid crystalline polymer resin to satisfy heat resistance and stiffness. Here, the nip plate 142 and the nip plate holding members 143 and 144 are collectively referred to as a nip-forming member since the nip plate 142 forms a nip portion with the pressurizing roller 110 in a state where the nip plate and the nip plate holding members have been combined into the fixing apparatus. In addition, the nip plate 142 and the nip plate holding members 143 and 144 may form the nip-forming member as a single body. In the nip-forming member, a surface that forms the nip portion with the pressurizing roller 110 is designated as a first side, and a surface opposite to the first side is designated as a second side.

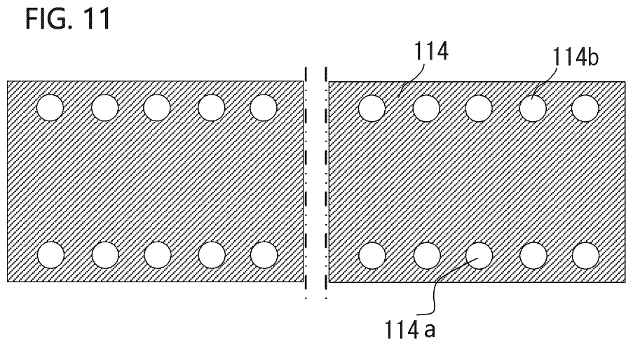

The sliding sheet 114 is a sheet-like member having an elongated rectangular shape, and, as shown in FIG. 11, before being mounted, opening portions 114a and 114b for mounting are provided at a plurality of places along the longitudinal direction in the vicinities of the end portions in the transverse direction. In the drawing, the longitudinal-direction middle portion omitted is indicated by dashed-two dotted lines.

The nip plate holding members 143 and 144 include a plurality of convex portions 143a and 143b for mounting the sliding sheet 114 along the longitudinal direction on the rear surface (the surface opposite to the fixing nip N). The sliding sheet 114 is mounted so as to cover the nip plate 142 and the nip plate holding members 143 and 144 on which the nip plate 142 has been mounted along them. The convex portions 143a and 144a of the nip plate holding members 143 and 144 are inserted into the opening portions 114a and 114b at the both widthwise ends. After that, the pressurizing stay 119 is mounted, whereby the sliding sheet 114 is put into a state of being sandwiched between the pressurizing stay 119 and the nip plate holding members 143 and 144 along the longitudinal direction. After that, each member is combined into the fixing apparatus, whereby a pressurizing force attributed to the pressurizing stay 119 is applied to the nip plate holding members 143 and 144. This makes the sliding sheet 114 sandwiched by the pressurizing stay 119 and the nip plate holding members 143 and 144 with a substantially uniform pressure in the longitudinal direction. Here, as described above, in the nip-forming member, when a surface that forms the nip portion with the pressurizing roller 110 is designated as a first side, and a surface opposite to the first side is designated as a second side, the sliding sheet 114 is sandwiched by the second side of the nip-forming member and the pressurizing stay 119.

Effect

In the present example, the same effect as in Example 1 can also be obtained in a fixing apparatus in which the vicinity of a fixing nip portion is heated using a halogen lamp. In the present example, the fixing apparatus may be configured so as to be capable of releasing the pressurizing force.

The halogen lamp 141, the reflecting plate 140, and the nip plate 142 can be considered as a heating member. In addition, the nip plate holding members 143 and 144 can be considered as a holding member. In that case, the heating member including the halogen lamp 141, the reflecting plate 140, and the nip plate 142 can be considered to correspond to the heater 113, which is the heating member in each of the above-described examples. In addition, the holding member including the nip plate holding members 143 and 144 can be considered to correspond to the heater holder 130, which is the holding member in each of the above-described examples.

In addition, as shown in FIG. 10B, step portions 143c and 144c may be provided to assist the fixation of the sliding sheet 114. The steps provided make it possible for the sliding sheet 114 to be mounted in a bent state, and thus an effect of fastening the sliding sheet 114 between the pressurizing stay 119 and the nip plate holding members 143 and 144 is further enhanced.

### Example 4

In Example 4, the disposition and shape of the sliding sheet 114 are different from those in the configuration described in Example 1. Other configurations are the same as in Example 1 and will thus not be described in detail.

Characteristics

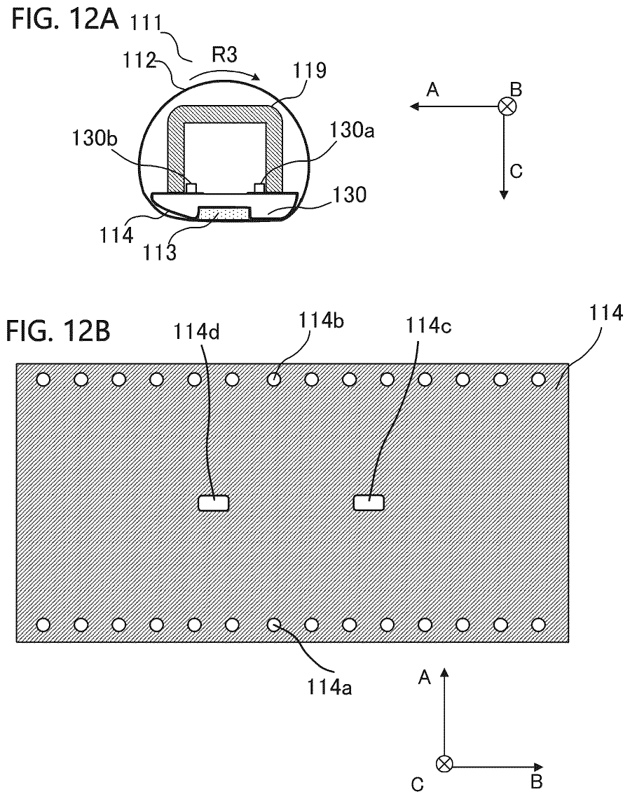

The disposition of the sliding sheet 114, which is a characteristic of the present example, will be described. As shown in FIG. 12A, the sliding sheet 114 of the present example is sandwiched between the heater 113 and the heater holder 130 across the length. Therefore, the sliding sheet 114 is present on a side opposite to the pressurizing roller when seen from the heater 113.

The upstream side convex portions 130a and the downstream side convex portions 130b of the heater holder 130 are inserted into the upstream side opening portions 114a and the downstream side opening portions 114b of the sliding sheet 114. After that, each member is combined into the fixing apparatus, and a pressurizing force attributed to the pressurizing stay 119 is applied, whereby the sliding sheet 114 is pressurized and sandwiched between the heater 113 and the heater holder 130 and between the heater holder 130 and the pressurizing stay 119 to be fixed.

Next, the shape of the sliding sheet 114 will be described. As shown in FIG. 12B, the sliding sheet 114 of the present example is provided with a temperature sensing element opening portion 114c and a safety element opening portion 114d. These opening portions make it possible for a thermistor, which is a temperature sensing element installed on a surface opposite to the heater sliding surface S, and a thermo switch, which is a safety element, to be in direct contact with the heater 113.

Effect

In the present example, since the sliding sheet 114 is fixed to the surface opposite to the heater sliding surface S, no wrinkles are generated in the sliding sheet 114 on the heater sliding surface S having a large influence on fixing performance. In addition, compared with Comparative Example 1, since the fixation intervals on the circumference of the sliding sheet 114 in the sliding direction become short, and longitudinally uniform pressurization and sandwiching becomes possible, it is also possible to reduce the generation of wrinkles on the upstream side and the downstream side of the heater sliding surface S in the conveyance direction.

### Modification Examples

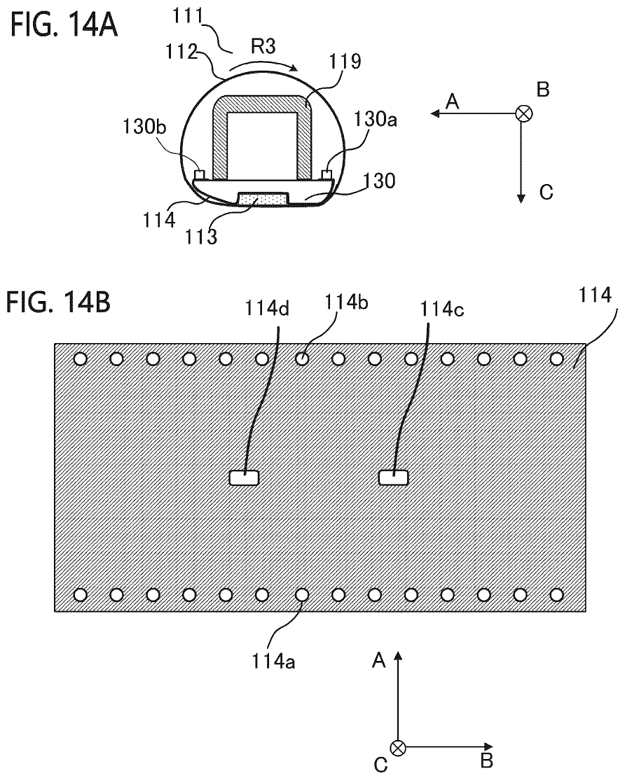

As Modification Example 1 of the present example, the disposition of convex portions 130a and 130b as in FIG. 14A is also possible. In this case, compared with the case of FIG. 12A, the generation of a wrinkle can be prevented more in FIG. 12A since the convex portions 130a and 130b on the circumference of the sliding sheet 114 are closer to the fixing nip N than the portions to be pressurized in the heater holder 130. However, the sliding sheet 114 is disposed between the heater 113 and the heater holder 130, which creates a bigger effect of wrinkle prevention than in conventional cases. In the case of the present modification example as well, as shown in FIG. 14B, the sliding sheet 114 is provided with a temperature sensing element opening portion 114c and a safety element opening portion 114d.

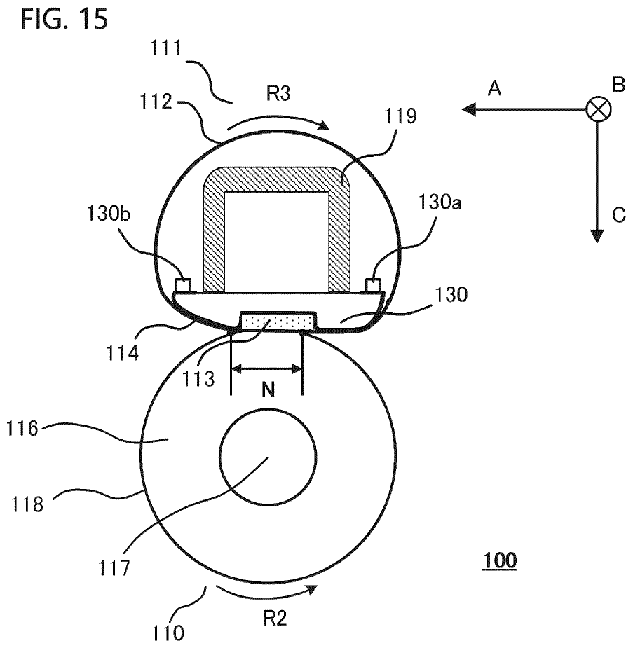

As Modification Example 2 of the present example, FIG. 15 shows a state in which the film unit 111 is shifted 1 mm upstream in the conveyance direction relative to the pressurizing roller 110. As described above, in conventional configurations, such a shift makes the heater holder 130 and the fixing film 112 strongly rub against each other, whereby the sliding resistance is likely to become large. However, in the present example, the heater holder 130 was covered with the sliding sheet 114, and thus no significant increase in sliding torque was shown.

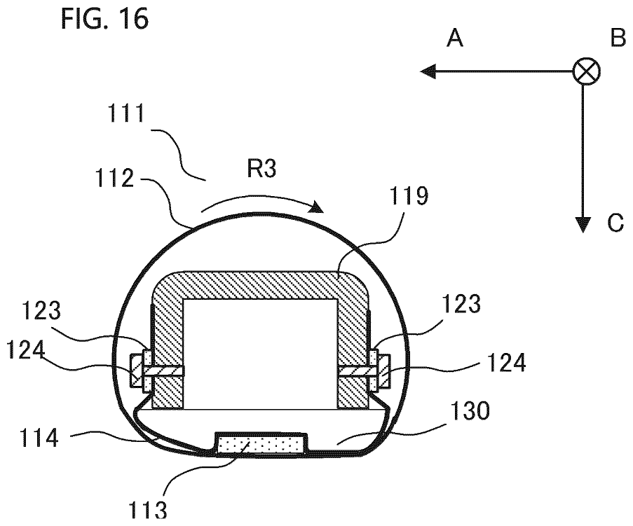

As Modification Example 2 of the present example, the sliding sheet 114 may be completely fixed to the pressurizing stay 119 with the planar metal plates 123 as shown in FIG. 16. Even in such a configuration, it is possible to prevent wrinkles or the like while securing slidability.

In the present example as well, the fixing apparatus may be configured so as to be capable of releasing the pressurizing force.

### Example 5

In Example 5, a fitting nip plate 148 is added as a fitting member. In addition, the disposition of the sliding sheet 114 or the shape of the nip plate 142 is different from that in Example 3. Other configurations are the same as in Example 3 and will thus not be described in detail.

Characteristics

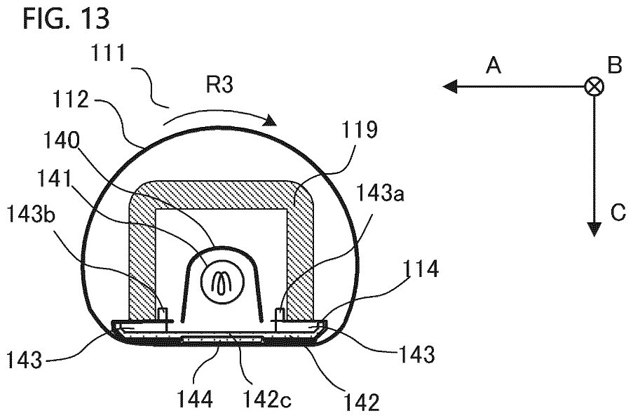

The shape of the nip plate 142 and the fitting nip plate 148, which are characteristics of the present example, will be described. As shown in FIG. 13, in the present example, unlike Example 3, the nip plate 142 has a depressed shape in a fitting portion 142c, and the fitting nip plate 148 can be loosely unfitted. In the present example, the fitting nip plate 148 is formed of an aluminum plate that is 6 mm in width in the recording material conveyance direction and 0.5 mm in thickness, and, normally, similar to the nip plate 142, a material having a high heat conductivity is used. In the present example, in order to efficiently transmit heat to the recording material P, the center of the fitting nip plate 148 and the center of the pressurizing roller 110 are matched in the recording material conveyance direction.

Next, the disposition of the sliding sheet 114 will be described. As shown in FIG. 13, the sliding sheet 114 of the present example is sandwiched between the fitting portion 142c of the nip plate 142 and the fitting nip plate 148 along the longitudinal direction, and the upstream side convex portions 143a and the downstream side convex portions 143b of the nip plate holding member 143 are inserted into the upstream side opening portions 114a and the downstream side opening portions 114b of the sliding sheet 114. After that, the pressurizing stay 119 is mounted, and the sliding sheet 114 is put into a state of being sandwiched between the pressurizing stay 119 and the nip plate holding member 143 across the length. After that, each member is combined into the fixing apparatus, and a pressurizing force attributed to the pressurizing stay 119 is applied, whereby the sliding sheet 114 is pressurized and sandwiched between the fitting portion 142c of the nip plate 142 and the fitting nip plate 148 and between the pressurizing stay 119 and the nip plate holding member 143 to be fixed.

Effect

In the present example, the same effects as in Example 4 in addition to Example 3 can also be obtained in a fixing apparatus in which the vicinity of the fixing nip N is heated using a halogen lamp. In addition, in the present example as well, the fixing apparatus may be configured so as to be capable of releasing the pressurizing force.

### Example 6

In Example 6, the disposition and shape of the sliding sheet 114 and the shape of the heater holder 130 are different from those in Example 4. Other configurations are the same as in Example 4 and will thus not be described in detail.

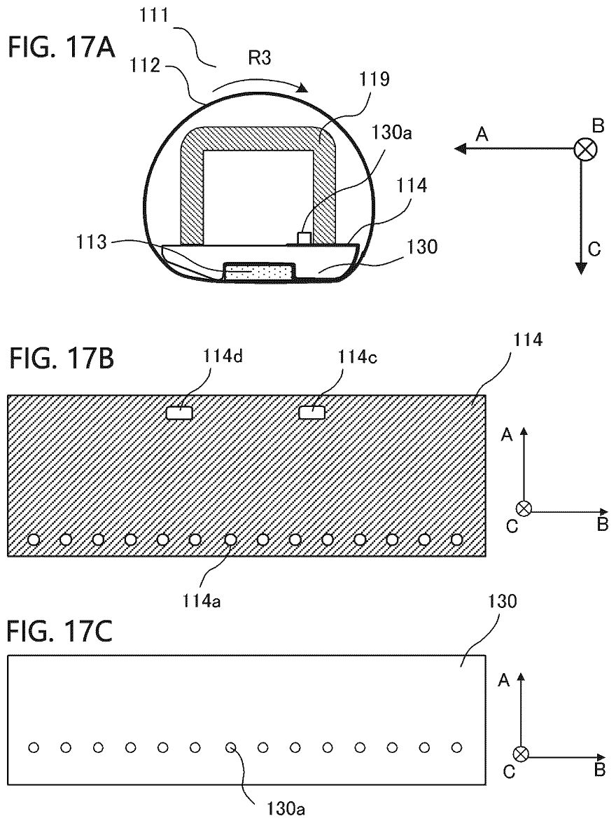

The disposition of the sliding sheet 114, which is a characteristic of the present example, will be described. As shown in FIG. 17A, in the sliding sheet 114 of the present example, one end in the sliding direction is a fixation end with the heater holder 130, and the other end is sandwiched between the heater 113 and the heater holder 130 along the longitudinal direction. The upstream side convex portions 130a of the heater holder 130 are inserted into the upstream side opening portions 114a of the sliding sheet 114. After that, when the pressurizing stay 119 is mounted, the sliding sheet 114 is sandwiched between the pressurizing stay 119 and the heater holder 130 along the longitudinal direction. After that, each member is combined into the fixing apparatus, and a pressurizing force is applied by the pressurizing stay 119, whereby the sliding sheet 114 is pressurized and sandwiched between the heater 113 and the heater holder 130 and between the pressurizing stay 119 and the heater holder 130 to be fixed.

Next, the shapes of the sliding sheet 114 and the heater holder 130 will be described. As shown in FIG. 17B and FIG. 17C, the downstream side opening portions 114b are not provided in the sliding sheet 114 of the present example, and the downstream side convex portions 130b are not provided in the heater holder 130.

Effect

The action and effect of the fixing apparatus in the present example will be described. In the present example, since the widthwise end portions of the sliding sheet 114 are pressurized and sandwiched between the pressurizing stay 119 and the heater holder 130 and between the heater 113 and the heater holder 130 to be fixed, respectively, the same effects as in Example 1 and Example 4 can be obtained. Here, the downstream side end portion of the sliding sheet 114 in the sliding direction is not fixed to the heater holder 130, but is sandwiched and fixed between the heater 113 and the heater holder 130.

The sliding sheet 114 may be mounted downstream depending on the slidability of a fixing unit. In addition, in the present example as well, the fixing apparatus may be configured so as to be capable of releasing the pressurizing force.

### Example 7

In Example 7, the disposition and shape of the sliding sheet 114 and the shape of the heater holder 130 are different from those in Example 4. Other configurations are the same as in Example 4 and will thus not be described in detail.

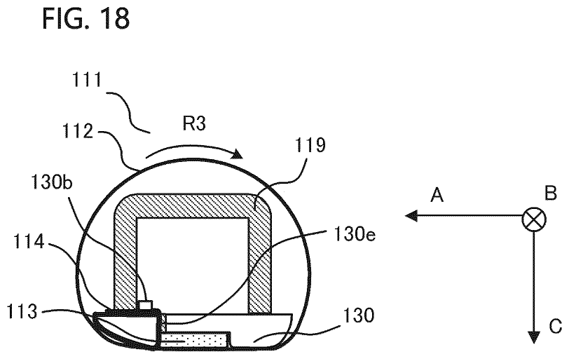

As shown in FIG. 18, in the present example, the downstream side convex portions 130b of the heater holder 130 are inserted into the downstream side opening portions 114b of the sliding sheet 114. The sliding sheet 114 is also wound around the downstream side of the heater holder 130. Furthermore, the downstream side convex portions 130b of the heater holder 130 are also inserted into the upstream side opening portions 114a of the sliding sheet 114. Therefore, the downstream side convex portions 130b are inserted into both of the opening portions 114b and 114a. In addition, the sliding sheet 114 overlaps itself in the portions to be pressurized by the pressurizing stay 119. After that, the pressurizing stay 119 is mounted, whereby the portions where the sliding sheet 114 overlaps itself are put into a state of being sandwiched between the pressurizing stay 119 and the heater holder 130 along the longitudinal direction. After that, each member is combined into the fixing apparatus, and the sliding sheet 114 is pressurized by the pressurizing stay 119, whereby the sliding sheet 114 is pressurized and sandwiched between the pressurizing stay 119 and the heater holder 130 to be fixed.

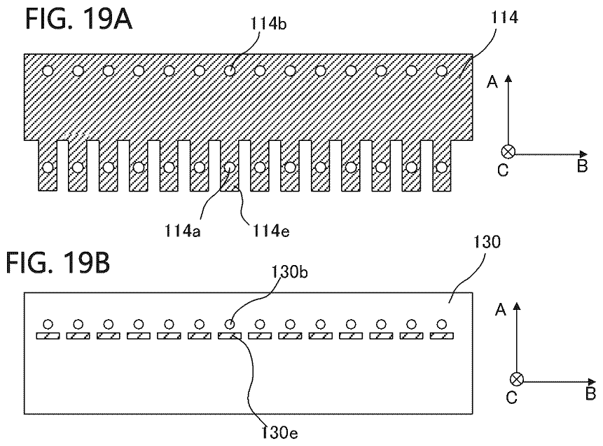

The shape of the sliding sheet 114 of the present example is shown in FIG. 19A. Comb teeth-like inserting portions 114e are formed across the length on the upstream side of the sliding sheet 114 of the present example. In addition, the upstream side opening portions 114a are provided in the inserting portions 114e.

The shape of the heater holder 130 of the present example is shown in FIG. 19B. In the heater holder 130 of the present example, the downstream side convex portions 130b and the opening portions 130e are provided at a plurality of places along the longitudinal direction. Such a configuration makes the inserting portions 114e of the sliding sheet 114 inserted into the opening portions 130e of the heater holder 130, whereby the sliding sheet 114 is wound around the downstream side of the heater holder 130.

Effect

In the present example, the sliding sheet 114 is wound around and fixed to the downstream side of the heater holder 130, and the end portion of the sliding sheet 114 in the transverse direction is pressurized and sandwiched between the pressurizing stay 119 and the heater holder 130 to be fixed. Therefore, the same effects as in Example 1 and Example 4 can be obtained.

The sliding sheet 114 may be wound around the upstream side of the heater holder 130 depending on the slidability of the fixing unit. In addition, in the present example as well, the fixing apparatus may be configured so as to be capable of releasing the pressurizing force.

### Modification Examples

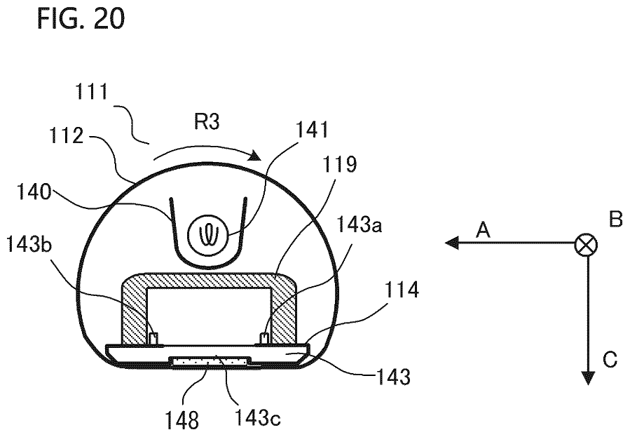

FIG. 20 is a modification example in a fixing apparatus with a system of using the halogen lamp 141. In the present modification example, the halogen lamp 141 and the reflecting plate 140 directly heat the fixing film 112. In this case, when a material having a low heat conductivity is used as the nip plate holding member 143 and the fitting nip plate 148, a heat insulation effect for the fixing film 112 can be enhanced. In the present modification example, a fitting portion 143c is provided in the nip plate holding member 143, and the sliding sheet 114 is sandwiched between the fitting portion 143c of the nip plate holding member 143 and the fitting nip plate 148 across the length.

(II)

In a fixing apparatus in which the slidability between a fixing film and a heater is secured using a sliding sheet, a configuration in which a notch portion is provided in the sliding sheet has been proposed. This intends to suppress the distortion or defect of an image by preventing wrinkles in the sliding sheet. This makes it possible to prevent wrinkles in the sliding sheet, but there is a concern that it may become impossible to obtain uniform fixing performance in a case where so-called small-sized paper (for example, B5 paper or A5 paper) has been fed. This is because the sliding sheet in the notch portion overlaps itself, which makes unevenness generated in a fixing nip region and causes uneven heat transmission to the fixing film or an uneven pressure distribution on the surface of paper at the time of feeding the paper. As a method for preventing this, a method in which the thickness of the sliding sheet is thinned or the like can be considered. However, in a case where there is a need to transmit heat on the rear surface of the sliding sheet to the front surface of the fixing film, as the thickness of the sliding sheet becomes thinner, the heat resistance becomes smaller, but the stiffness becomes weaker. Therefore, even for small-sized paper, there is a need to suppress wrinkles in the sliding sheet.

### Example 8

### Fixing Apparatus

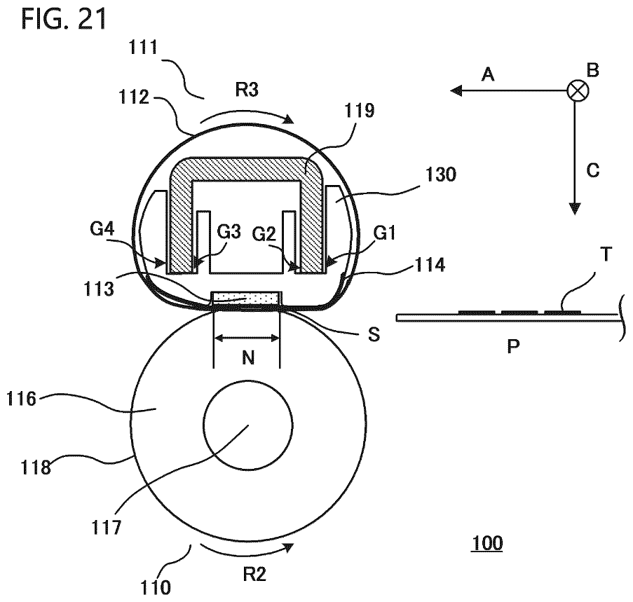

The main body configuration of an image forming apparatus in the present example is the same as the above description for which FIG. 1 is used and will thus not be described in detail. A fixing apparatus 100 of the present example is also an on-demand heating system fixing apparatus intended to shorten the rise time or reduce power consumption. FIG. 21 is a cross-sectional view of the vicinity of a longitudinal central portion of the fixing apparatus 100.

Differences between FIG. 2 and FIG. 21 are the shape of a heater holder 130 and the disposition of a sliding sheet 114. A pressurizing stay 119 is disposed along the longitudinal direction of the heater holder 130. The pressurizing stay 119 is configured by bending a highly stiff metal plate of iron, stainless steel or the like in order to uniformly pressurize the heater holder 130 in the longitudinal direction. Gaps are provided in a recording material conveyance direction A between the pressurizing stay 119 and depressed portions, which are portions in the heater holder 130 for receiving the pressurizing stay. The gaps between the heater holder 130 and the pressurizing stay 119 are designated as gaps G1, G2, G3, and G4 in order from the upstream side in the conveyance direction. The sizes of these gaps are set in consideration of deformation, a dimensional variation during manufacturing, or the like attributed to the thermal expansion of the heater holder 130 and the pressurizing stay 119.

Heater Holder Deformation in Case where Large-Sized Paper has been Fed

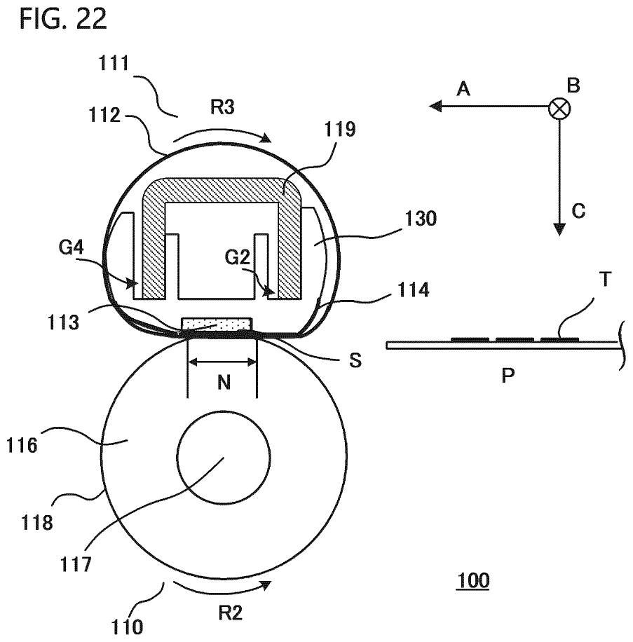

FIG. 22 is a cross-sectional view of the vicinity of a central part of the fixing apparatus 100 in a longitudinal direction B in a case where so-called large-sized paper (for example, LTR paper or A4 paper) has been fed.

In this case, in the fixing apparatus 100, the heater holder 130 moves downstream in the recording material conveyance direction A relative to the pressurizing stay 119, and the gaps G1 and G3 on the upstream side in the recording material conveyance direction A, which have been described above, disappear. This is because the sliding sheet 114 receives a friction force due to sliding on the inner surface of the fixing film 112 and receives a force that is exerted in the recording material conveyance direction A in the fixing nip N. In addition, both end portions of the heater holder 130 (film unit 111) in the longitudinal direction B are fixed between the right and left side-plates 134 of an apparatus frame 133 and thus do not move downstream due to the rotation of the fixing film 112. That is, during the feeding of large-sized paper, the heater holder 130 deforms in an arch shape where the central part in the longitudinal direction B protrudes downstream in the conveyance direction A.

Temperature Increase in Non-Paper Feeding Portion in Case Small-Sized Paper has been Fed

In on-demand heating system fixing apparatuses in which LTR paper is the maximum feedable paper, normally, the width of a heat generating member in the longitudinal direction B is also large enough to handle LTR paper. In a case where small-sized paper (for example, B5 paper) has been continuously fed into such a fixing apparatus, there are cases where the surface temperature of a non-paper feeding region (outside a region where the recording material P passes during conveyance) in the pressurizing roller 110 increases excessively compared with a case where large-sized paper has been fed. This is because, in the non-paper feeding region in the fixing nip N where the recording material P does not pass, heat is not lost by the recording material P and thus heat storage occurs partially. This phenomenon is referred to as “temperature increase in non-paper feeding portion”. In this case, the surface temperature of the pressurizing roller 110 has a thermal peak outside the paper feeding region and in the heat generating member region.

Heater Holder Deformation in Case where Small-Sized Paper has been Fed

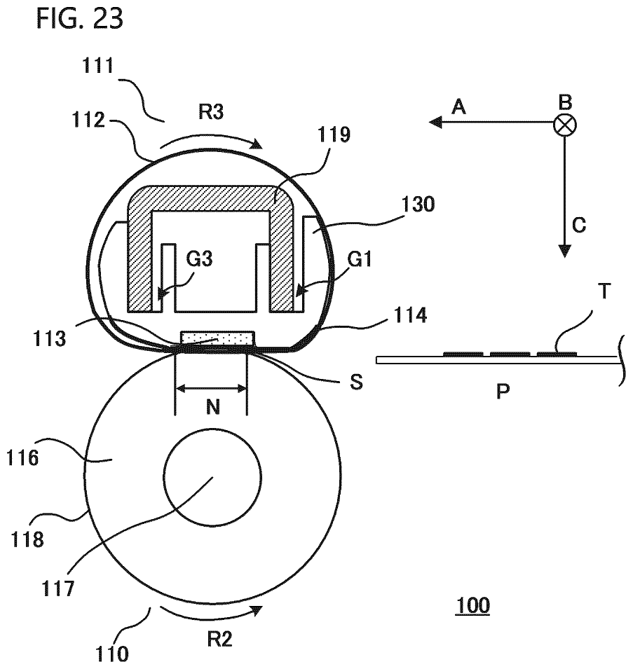

FIG. 23 is a cross-sectional view of the vicinity of the central part of the fixing apparatus 100 in the longitudinal direction B in a case where so-called small-sized paper (for example, B5 paper or A5 paper) has been fed.

In this case, the heater holder 130 moves upstream in the recording material conveyance direction A relative to the pressurizing stay 119, and the gaps G2 and G4 on the downstream side in the recording material conveyance direction A disappear. This relates to the temperature increase in the non-paper feeding portion in the pressurizing roller 110 when small-sized paper is fed, which has been described above. Ordinarily, in the pressurizing roller 110 where the elastic layer is formed of silicone rubber, the thermal expansion of the outer diameter becomes larger and the conveyance force becomes higher in a non-paper feeding region (a second region as a region that corresponds to a region where the recording material does not pass in the fixing nip) than in a paper feeding region (a first region as a region that corresponds to a region where the recording material passes in the fixing nip). This phenomenon becomes significant in a case where small-sized paper, which makes the non-paper feeding region wide, has been fed. Therefore, in a case where small-sized paper or the like has been continuously fed, the conveyance force at the central portion of the heater holder 130 in the longitudinal direction B becomes relatively low compared with the conveyance force in both end portions. As a result, the heater holder 130 in the central portion moves upstream as shown in FIG. 23.

In addition, both end portions of the heater holder 130 (film unit 111) in the longitudinal direction B are fixed between the right and left side-plates 134 of an apparatus frame 133 and thus do not move downstream due to the rotation of the fixing film 112. Therefore, during the feeding of small-sized paper, the heater holder 130 deforms in an arch shape where the central part in the longitudinal direction B protrudes upstream in the conveyance direction. In the present example and Comparative Example 1 and Comparative Example 2, which will be described below, the amount of the central portion of the heater holder 130 moved upstream in a case where B5 paper had been continuously fed at 30 ppm was a maximum of approximately 300 μm.

Form of Sliding Sheet

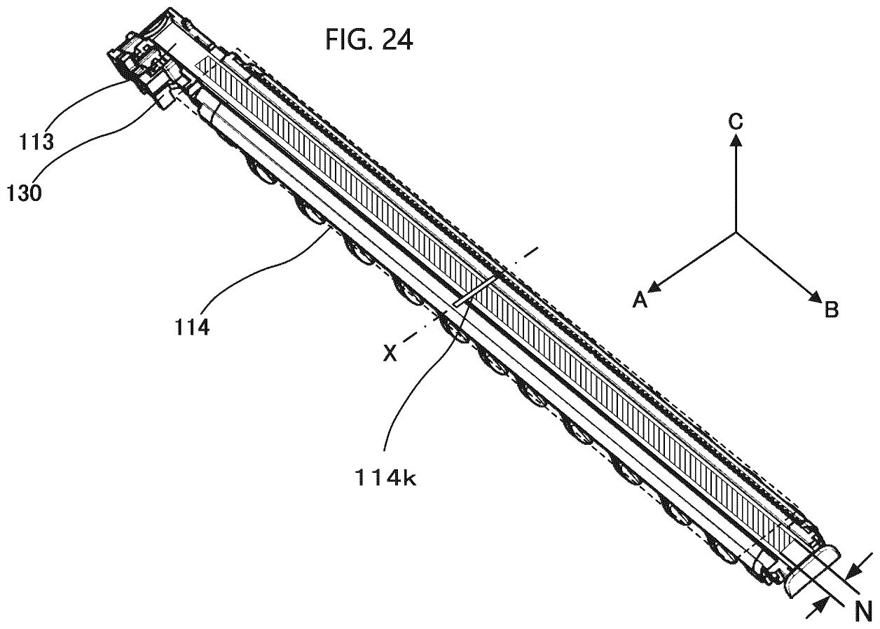

Next, the form of the sliding sheet 114 in the vicinity of the fixing nip N, which is a characteristic configuration of the present invention, will be described in detail. FIG. 24 is a perspective view of the heater holder 130 and the sliding sheet 114 in the present example. The sliding sheet 114 is a sheet-like member having an elongated rectangular shape. The sliding sheet 114 is disposed so as to come into contact with the surface of the heater 113 held on the heater holder 130. The sliding sheet 114 is indicated with dashed lines in order to make the sliding sheet easily noticeable.

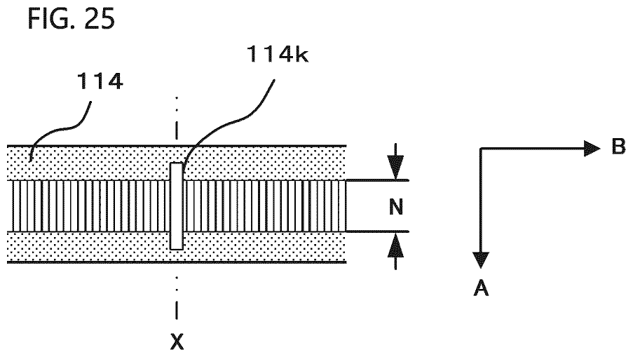

FIG. 25 shows an opening portion 114k provided in the sliding sheet 114. In the sliding sheet 114, the opening portion 114k that is 9.5 mm in width in the recording material conveyance direction A and 1.0 mm in width in the longitudinal direction B is provided at a position matching a center X of the recording material P in the longitudinal direction B. The opening portion 114k is disposed, in the region of the fixing nip N, at a position where the sliding sheet 114 is divided in the longitudinal direction B.

Effect

An action of the present invention that improves the distortion or defect of an image attributed to the deformation of the heater holder 130 will be described.

### Comparative Example 1

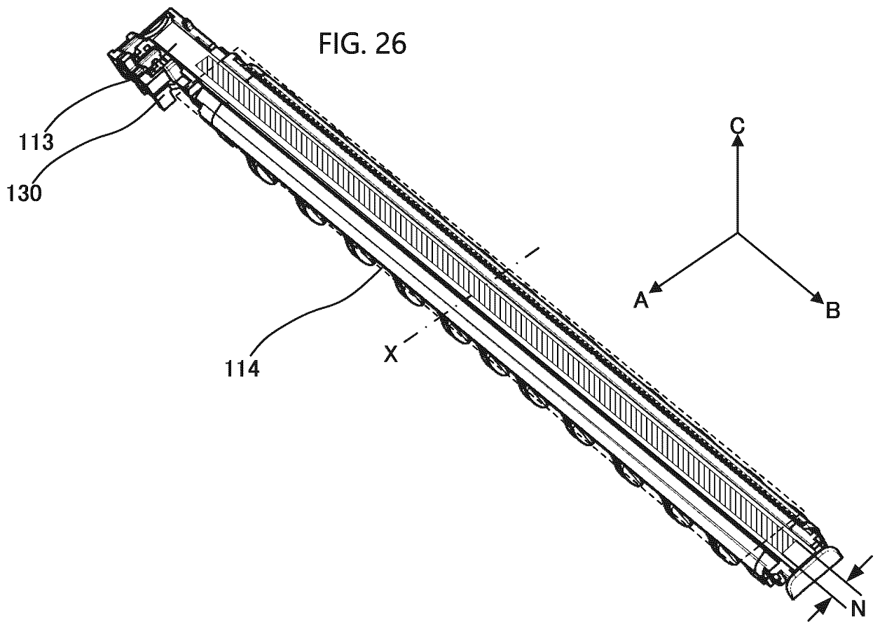

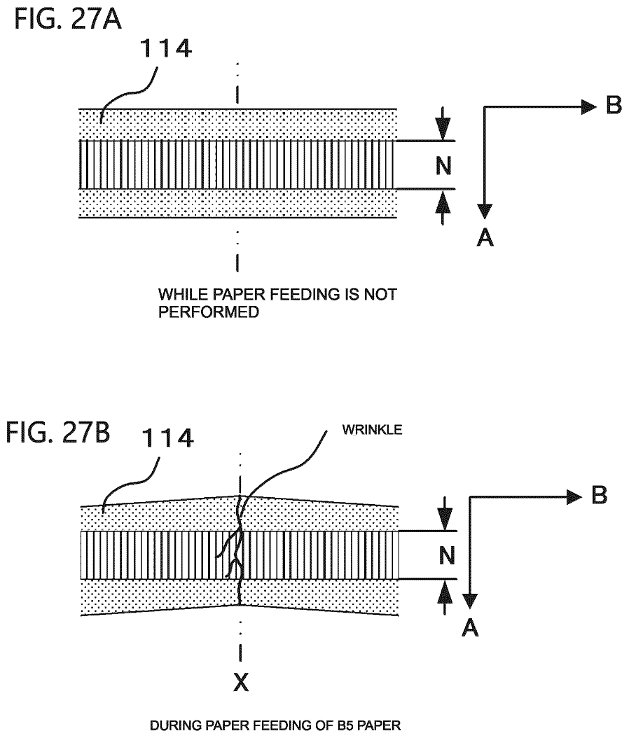

FIG. 26 is a perspective view of the heater holder 130 and the sliding sheet 114 in Comparative Example 1, and the fact that the opening portion 114k is not provided in the sliding sheet 114 is different from Example 1. As a result of evaluating the continuous paper feeding of B5 paper at 30 ppm using an image forming apparatus 50 including this fixing apparatus 100, a wrinkle was generated in the central portion of the recording material P in the longitudinal direction B, and a fixing defect was generated. This is because the sliding sheet 114 is put into a state where wrinkles have been generated as shown in FIG. 27B from a state where paper feeding was not performed as shown in FIG. 27A due to continuous paper feeding. A cause of such generation of wrinkles is that the sliding sheet 114 is not capable of flexibly following the arch-shaped deformation of the heater holder 130 during the paper feeding of the B5 paper and deforms. In the region of the fixing nip N, wrinkles are generated in the sliding sheet 114 having the convex portions with respect to the surface of the heater 113, and, consequently, a fixing defect is generated.

### Comparative Example 2

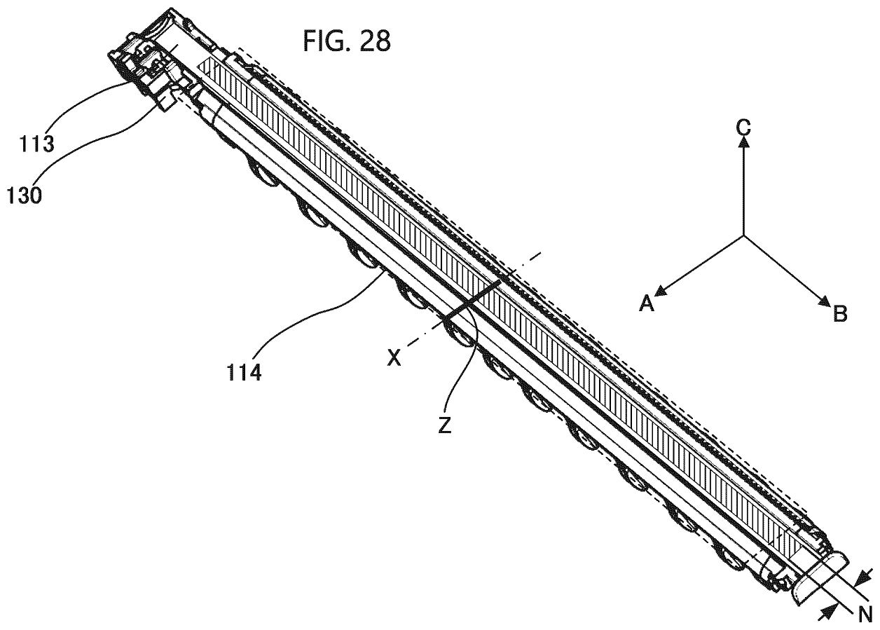

FIG. 28 is a perspective view of the heater holder 130 and the sliding sheet 114 in Comparative Example 2. In a sliding sheet 114 of Comparative Example 2, a notch portion Z is provided on the downstream side in the recording material conveyance direction A.

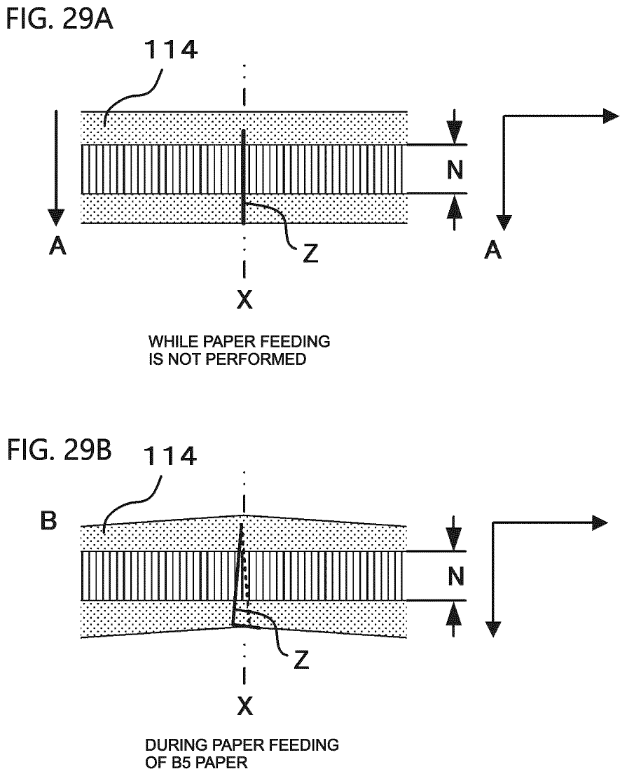

Next, FIG. 29A is a view for describing the notch portion Z. In the sliding sheet 114, the notch portion Z that is 9.5 mm in width in the recording material conveyance direction A is provided at a position matching a center X of the recording material P in the longitudinal direction B. The notch portion Z is formed, in the region of the fixing nip N, at a position where the sliding sheet 114 is divided in the longitudinal direction B.

As a result of evaluating the continuous paper feeding of B5 paper at 30 ppm using an image forming apparatus 50 including this fixing apparatus 100, wrinkles were not generated in the recording material P. This is because, as shown in FIG. 29B, the notch portion Z in the sliding sheet 114 acted to prevent the generation of a wrinkle in the fixing nip with respect to the arch-shaped deformation of the heater holder 130 during the paper feeding of the B5 paper. Incidentally, in Comparative Example 2, regarding the image quality, a minor fixing defect was generated in the central portion of the recording material P in the longitudinal direction B. This is considered to arise from the fact that, in the region of the fixing nip N, the divided sliding sheets 114 adjacent to each other overlap each other, which causes poor heat transmission to the fixing film 112.

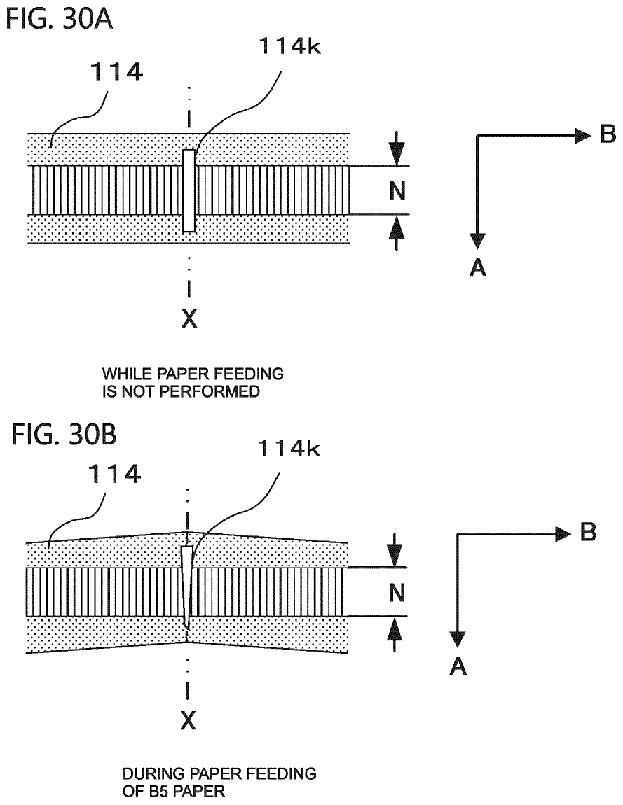

Next, the action and effect of the present example will be described. In the present example, as shown in FIG. 30A, the opening portion 114k is disposed, in the region of the fixing nip N, at a position where the sliding sheet 114 is divided in the longitudinal direction B. The opening portion 114k is provided at the position matching the center X of the recording material P in the longitudinal direction B.

As a result of evaluating the continuous paper feeding of B5 paper at 30 ppm using the image forming apparatus 50 including this fixing apparatus 100, wrinkles were not generated in the recording material P. In addition, regarding the image quality as well, there was no case where an abnormal image such as a fixing defect was generated. This is because, when the heater holder 130 deformed in an arch shape during the paper feeding of the B5 paper, the opening portion 114k in the sliding sheet 114 also deformed as shown in FIG. 30B. That is, the opening portion 114k is considered to prevent the generation of a wrinkle in the region of the fixing nip N and to prevent the divided sliding sheets 114 from overlapping each other.

In the present example, it has been confirmed that, as long as the shape of the opening portion 114k provided in the sliding sheet 114 is at least 6.5 mm in width in the recording material conveyance direction A and at least 0.7 mm in width in the longitudinal direction B, the same effect as described in the present example can be obtained.

### Modification Examples

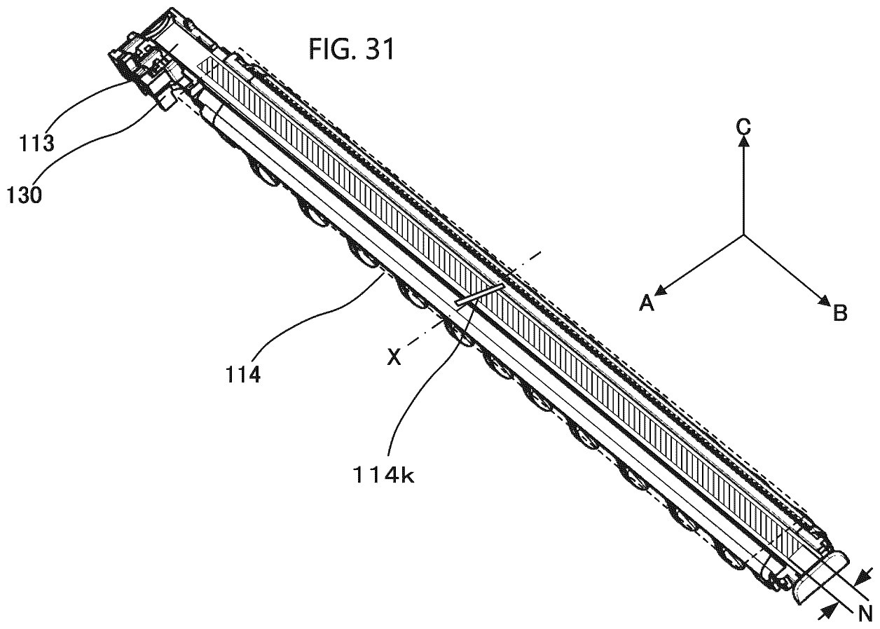

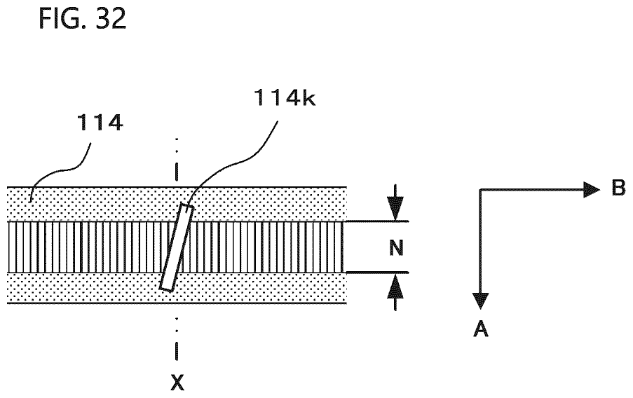

In the present example, the shape of the opening portion 114k provided in the sliding sheet 114 was set to a rectangular shape, and the opening portion 114k was formed at a position where the long side of the rectangular shape becomes parallel to the conveyance direction. However, the position of the opening portion 114k is not limited thereto as long as the effects of wrinkle prevention and sliding sheet overlapping prevention can be obtained. For example, the opening portion may be disposed such that the long side of the rectangular shape is inclined with respect to the recording material conveyance direction A as shown in FIG. 31 and FIG. 32. In addition, the shape of the opening portion 114k is also not limited to the present example.

In addition, in the present example, the sliding sheet 114 was configured to have the opening portion 114k. However, the sliding sheet 114 may be configured to be divided in the longitudinal direction B in the fixing nip N. In that case, the opening portion is referred to as a division portion. For example, each of the divided sheets may be an independent configuration.

### Example 9

Example 9 is the addition of a change to the configuration of the opening portion 114k provided in the sliding sheet 114, and other configurations are the same as in Example 8 and will thus not be described in detail.

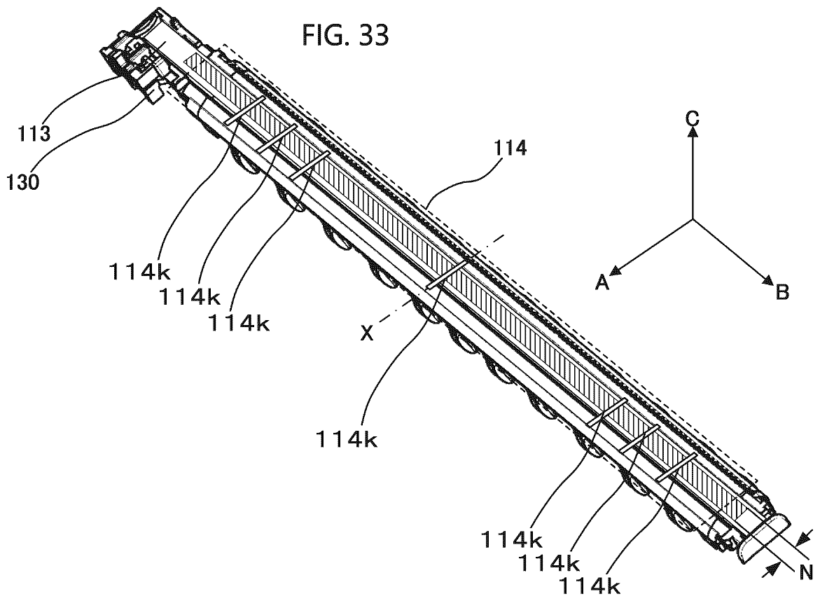

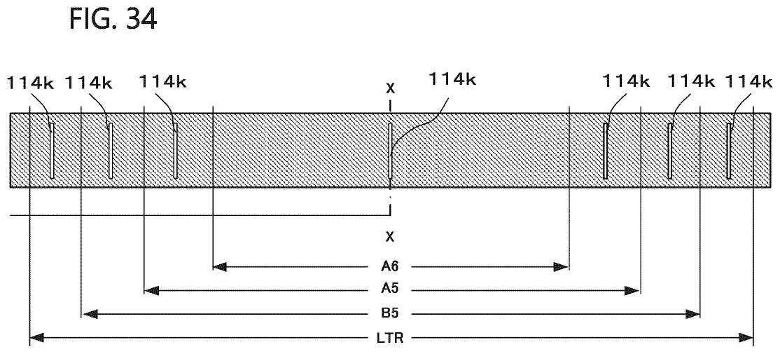

FIG. 33 is a perspective view of the heater holder 130 and the sliding sheet 114, which are characteristics of the present example. FIG. 34 is an explanatory view for describing the positional relationship between the opening portion 114k of the sliding sheet 114 in the present example and small-sized paper in the longitudinal direction B. In the sliding sheet 114 of the present example, a plurality of the opening portions 114k is provided in the longitudinal direction B. In the present example, the opening portions 114k are provided at a total of seven places, that is, six places at which the opening portions 114k are each positioned in the middle between the paper end portions of three kinds of paper (A6, A5, and B5) having different paper sizes in addition to the center X of the recording material P in the longitudinal direction B, where the opening portion is disposed in Example 8.

The size of each opening portion 114k is set to 9.5 mm in width in the recording material conveyance direction A and 0.5 mm in width in the longitudinal direction B. The fact that the opening portion 114k is disposed, in the region of the fixing nip N, at a position where the sliding sheet 114 is divided in the longitudinal direction B is the same as in Example 8.

Effect

The deformation amount of the opening portion 114k per place can be decreased by providing a plurality of the opening portions 114k in the sliding sheet 114 as in the present example. Therefore, the followability with respect to the deformation of the heater holder 130 improves more than in Example 8.

The width of the opening portion 114k in the longitudinal direction is preferably as small as possible from the viewpoint of the longitudinal uniformity of the fixing performance. Here, in the present example, the width of the opening portion 114k in the longitudinal direction is smaller than that in Example 1, but the same effect as in Example 1 can be obtained by providing a plurality of the opening portions 114k.

In addition, as small-sized standard paper, there are a variety of basis weights or paper sizes aside from the B5 paper fed in Example 1. That is, the deformation amount of the heater holder 130 accompanied by the temperature increase in the non-paper feeding portion in the pressurizing roller 110 changes depending on not only the state exemplified in Example 8 but also small-sized paper to be used. That is, when the opening portions 114k are disposed in the non-paper feeding portion regions of small-sized standard papers, respectively, as in the present example, even in a case where a variety of small-sized standard papers have been fed, it is possible to suppress wrinkles in the sliding sheet 114 or a fixing defect attributed to the sliding sheets 114 overlapping each other.

In the present example, the opening portions 114k are provided at seven places in the sliding sheet 114 in the longitudinal direction B, but the configuration is not limited thereto. The position, number, and shape of the opening portion 114k can be determined as appropriate depending on the apparatus configuration or the purpose such as the suppression of a fixing defect.

### Example 10

In Example 10, the present invention was applied to a fixing apparatus in which a halogen lamp was used. Configurations other than a film unit 111 are the same as in Example 8 and will thus not be described in detail.

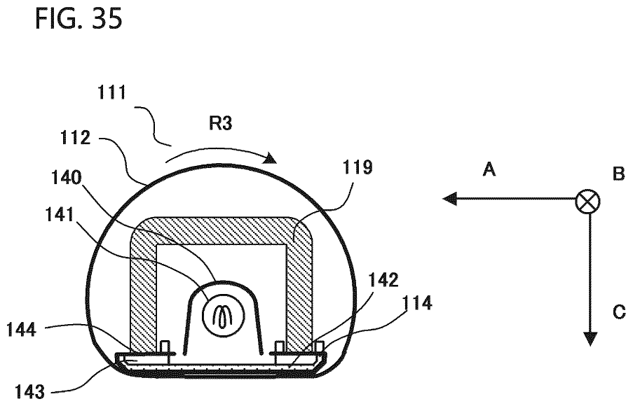

FIG. 35 shows the film unit 111 of the present example. The film unit 111 includes a pressurizing stay 119, a reflecting plate 140, a halogen lamp 141 as a heat source, a nip plate 142, a sliding sheet 114, and a fixing film 112. The material or configuration of each member is generally the same as that described using FIG. 10A and will thus not be described.

The sliding sheet 114 of the present example is, similar to Example 8, a sheet-like member having an elongated rectangular shape. The opening portion 114k that is 9.5 mm in width in the recording material conveyance direction A and 1.0 mm in width in the longitudinal direction B is provided at the position matching the center X of the recording material P in the longitudinal direction B in the sliding sheet 114.

Effect

According to the configuration of the present example, the same effect as in Example 8 can also be obtained in a fixing apparatus in which the vicinity of a fixing nip portion is heated using a halogen lamp.

(III)

In fixing apparatuses configured to include a sliding sheet, there are cases where the thermal conductivity from a nip plate to a fixing film deteriorates due to the sliding sheet interposed between a heating source such as a heater or a halogen lamp and the inner surface of the fixing film. There is a possibility that the rise time of the fixing film may become long. Therefore, there is a need to suppress the deterioration of the thermal conductivity in fixing apparatuses including a sliding sheet.

### Example 11

The schematic configurations of an image forming apparatus and a fixing apparatus in the present example are the same as the above description for which FIG. 1 to FIG. 3 are used. The same portions as in the above-described examples will not be described. The fixing apparatus 100 of the present example is an on-demand heating system fixing apparatus intended to shorten the rise time or reduce power consumption.

In the present example, a fluorine-based grease was used as a lubricant in order to reduce a friction force that was exerted between the heater 113 and the inner circumferential surface of the fixing film 112 or a friction force that was exerted between the sliding sheet 114 and the inner circumferential surface of the fixing film 112. Specifically, 250 mg of the grease was spray-applied 210 mm that was slightly shorter than 220 mm, which was the width of a pressurization region of the pressurizing roller 110 in the longitudinal direction on the heater sliding surface. Ordinarily, the lubrication performance of lubricants gradually deteriorates while a printing operation is repeated. Particularly, in a case where the service life of a fixing apparatus is long, when the amount of a lubricant applied is too small, the lubrication performance lacks in the second half of the service life of the fixing apparatus. On the other hand, when the amount of the lubricant applied is too large, there are cases where the lubricant leaks from an end portion of the heater 113 or the fixing film 112 in the longitudinal direction. In this case as well, the lubricant lacks on the heater 113 and the inner circumferential surface of the fixing film 112, and the lubrication performance lacks in the second half of the service life of the fixing apparatus. In addition, ordinarily, lubricants are expensive, and application of a lubricant more than necessary increases the cost of fixing apparatuses. That is, the amount of a lubricant applied is preferably set to an appropriate amount suitable for the service life of fixing apparatuses. The service life of the fixing apparatus in the present example is assumed to be 100,000 times of paper feeding.

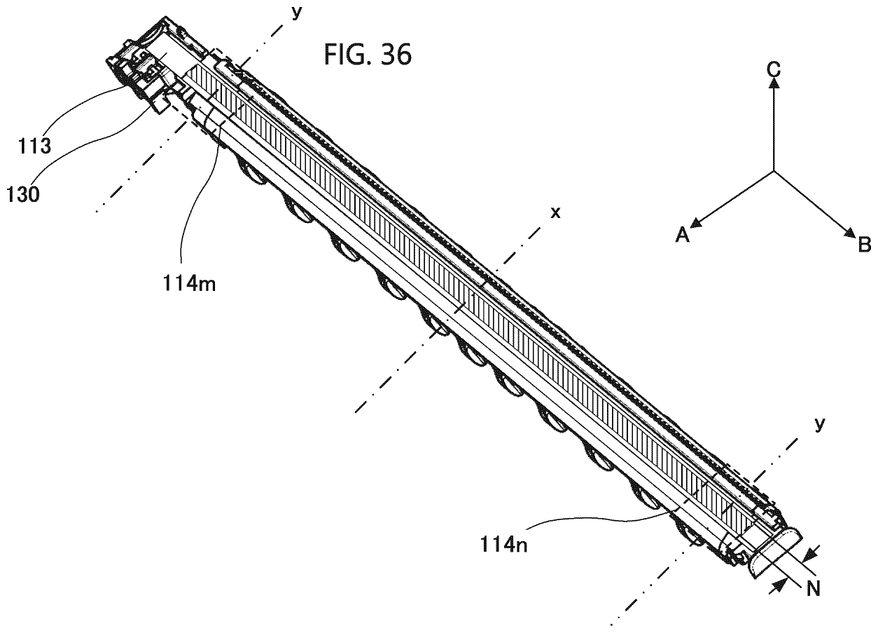

FIG. 36 is a perspective view of the heater holder 130 and the sliding sheet 114 of the present example. The sliding sheet 114 is a sheet-like member having a rectangular shape and is disposed so as to come into contact with the surface of the heater 113 held on the heater holder 130. The sliding sheets 114 of the present example are disposed at both end portions of the heater 113 in the longitudinal direction as sliding sheets 114m and 114n. In the drawing, the positions of the sliding sheets 114m and 114n are indicated with dashed lines in order to make the positions easily noticeable.

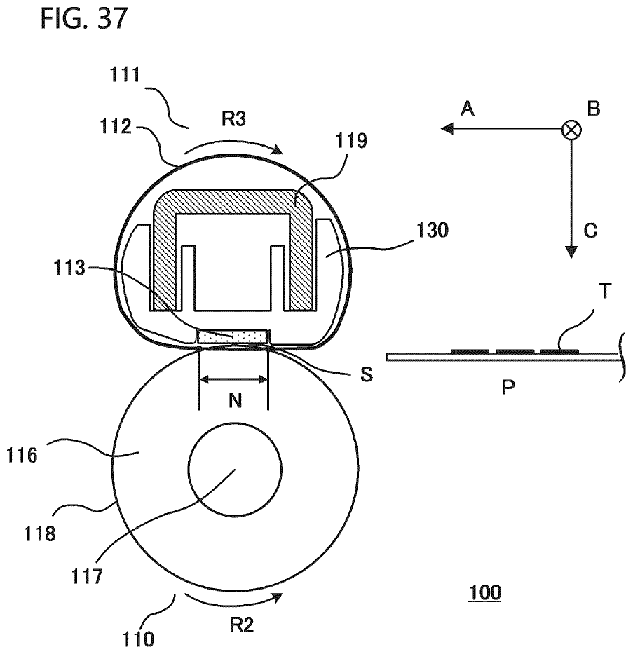

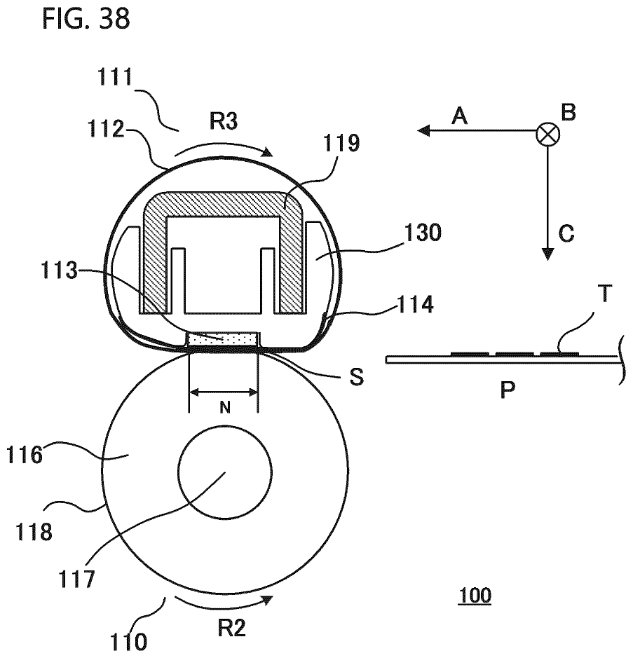

FIG. 37 is a cross-sectional view of the central portion of the fixing apparatus 100 in the longitudinal direction indicated by a dashed-dotted line x in FIG. 36. FIG. 38 is a cross-sectional view of an end portion of the fixing apparatus 100 in the longitudinal direction indicated by a dashed-two dotted line y in FIG. 36. As shown in FIG. 37, in the central portion of the fixing apparatus 100 in the longitudinal direction, the heater 113 as a heating member is held in the heater holder 130 as a holding member, and the fixing film 112 is provided so as to be in contact with the surface of the heater 113 in the configuration. The heater 113 slides on the inner surface of the fixing film 112 while heating the fixing film 112. The pressurizing roller 110 pressurizes the heater 113 from the outside of the fixing film 112.

As shown in FIG. 38, at the end portion of the fixing apparatus 100 in the longitudinal direction, the sliding sheet 114 having excellent lubricity and heat resistance is in contact with the surface of the heater 113. That is, the heater 113 heats the fixing film 112 through the sliding sheet 114 at the end portion. The sliding sheet 114 slides on the inner surface of the fixing film 112. The pressurizing roller 110 pressurizes the heater 113 through the sliding sheet 114 from the outside of the fixing film 112.

Form of Sliding Sheet

Next, the form of the sliding sheet 114 in the vicinity of the fixing nip N, which is a characteristic configuration of the present invention, will be described in detail. The sliding sheets 114 of the present example are disposed at both end portions outside the maximum image width of the present image forming apparatus in the longitudinal direction of the fixing nip N as the sliding sheets 114m and 114n.

The maximum image width mentioned here is the maximum width in the longitudinal direction of an electrostatic latent image that can be formed on the surface of the photosensitive drum 1 with the exposing apparatus 3. For example, the paper size of the maximum width that can be used as the recording material P is determined as LTR paper, and it is determined that no toner images are formed at both end portions (margins as the common name, 3 mm in each end portion) of LTR paper in the longitudinal direction. The maximum image width in this case becomes 210 mm, which is obtained by subtracting both end portions (3 mm at each end portion) from 216 mm, which is the width of LTR paper in the longitudinal direction.

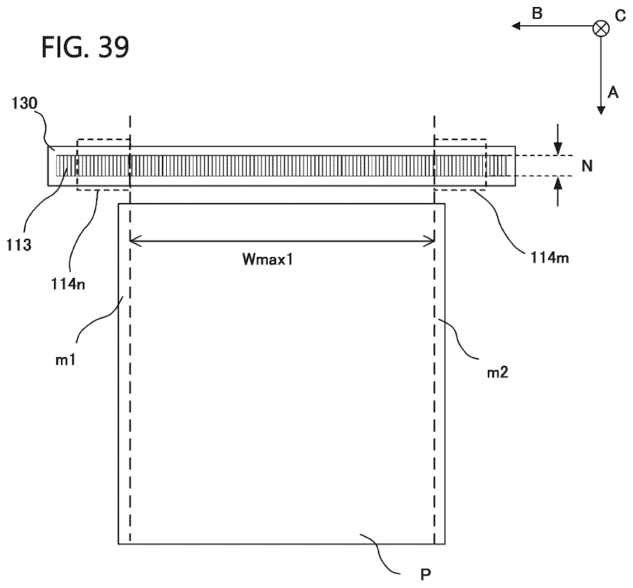

FIG. 39 is a schematic view showing the positional relationship between the recording material P and the sliding sheet 114 in the longitudinal direction in the present example. The above-described maximum image width is Wmax1 on the recording material P. Within the range of the maximum image width Wmax1, there is a possibility that a toner image may be formed. In such a configuration, the sliding sheets 114m and 114n are disposed outside of the maximum image width Wmax1 as indicated with dashed lines. As described above, in the fixing nip N, the sliding sheets 114 are not disposed in regions where a toner image is fixed onto the recording material P, whereby it is possible to efficiently transmit heat from the heater 113 to the fixing film 112. In addition, the sliding sheets 114 are disposed at the end portions, whereby the slidability of the fixing film can be secured. As a result, it becomes possible to satisfy both the slidability and the toner image fixing performance to the recording material P.

The portions of margin portions m1 and m2 are portions where no toner images are formed on the recording material P, and thus the sliding sheet 114 may be disposed therein.

The maximum image width described in the present example is an example and can be changed as appropriate depending on the configuration of the image forming apparatus. For example, in a case where the maximum width at which paper can be fed is the A4 size or a case where the widths of the margin portions are different, the maximum image width also changes. In addition, in image system apparatuses in which there are not margin portions and borderless print is possible, there are also cases where the paper width of the maximum width at which paper can be fed becomes the maximum image width as it is. Even in these cases, the same effect can be obtained by disposing the sliding sheets 114 outside of the maximum image width suitable for the image forming apparatus.

Effect

In the present example, the sliding sheets 114 are disposed outside of the maximum image width in the longitudinal direction of the fixing nip N, whereby the slidability and fixing performance of the fixing film 112 are both satisfied.

### Comparative Examples

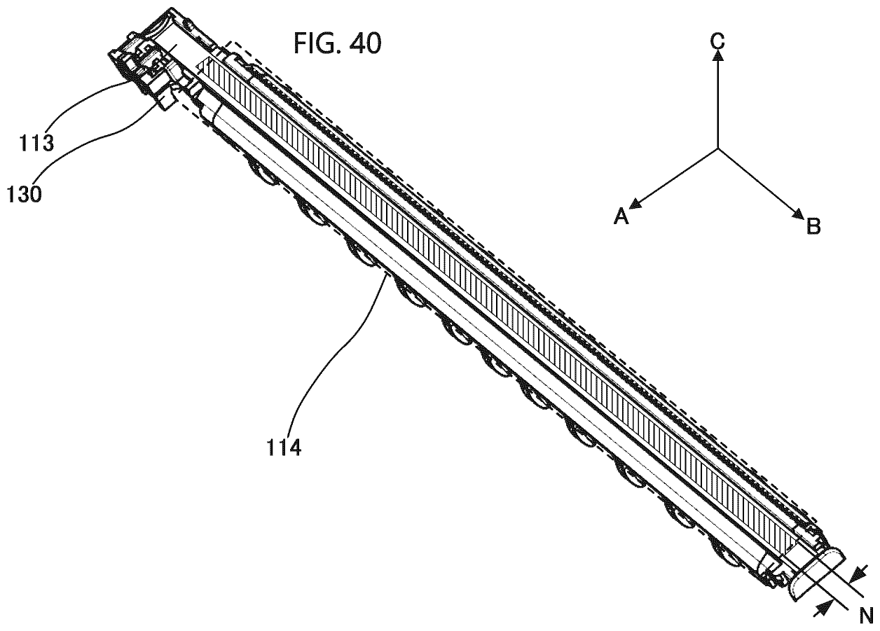

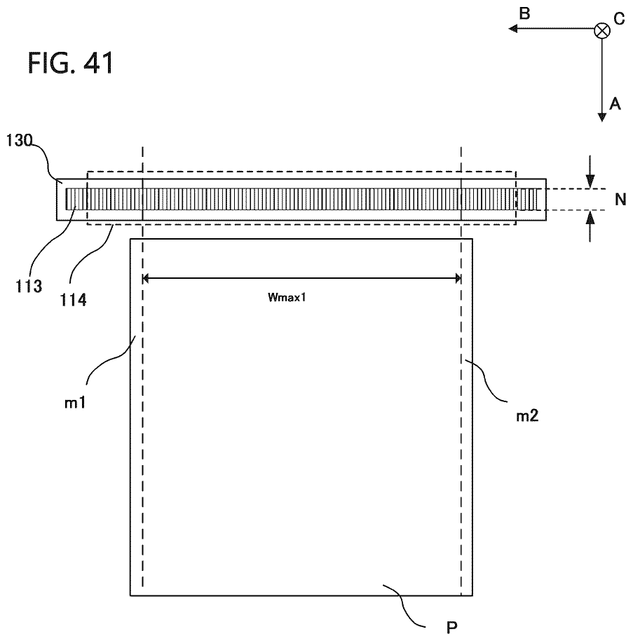

In order to describe the effect of the present example, an example where the sliding sheet 114 is disposed across the entire surface of the fixing nip N in the longitudinal direction will be described as Comparative Example 1. FIG. 40 is a perspective view of the heater holder 130 and the sliding sheet 114 of Comparative Example 1. FIG. 41 is a schematic view showing the positional relationship between the recording material P and the sliding sheet 114 in the longitudinal direction in Comparative Example 1.

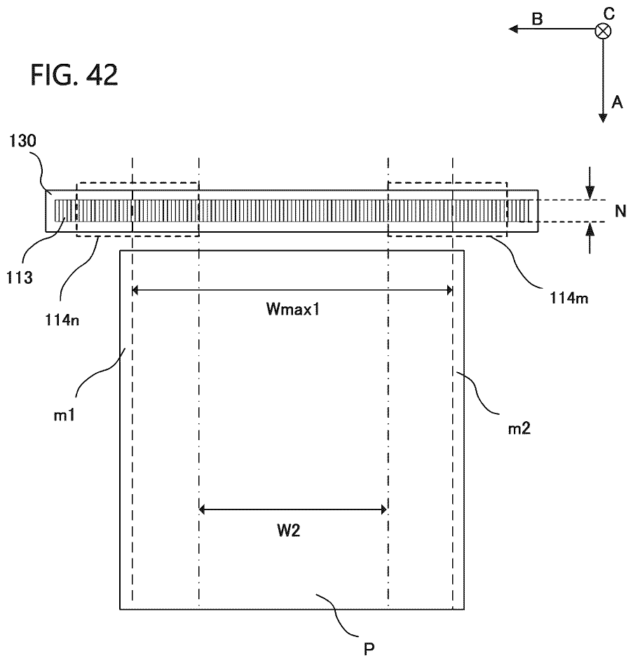

In addition, an example where the sliding sheet 114 is disposed inside of the maximum image width in the longitudinal direction of the fixing nip N will be described as Comparative Example 2. FIG. 42 is a schematic view showing the positional relationship between the recording material P and the sliding sheet 114 in the longitudinal direction in Comparative Example 2. In Comparative Example 2, there is a region where the sliding sheet 114 is not disposed (central portion W2) in the longitudinal direction. However, unlike the present example, the sliding sheet 114 is hung up to the region of the maximum image width Wmax1.

Evaluation conditions will be described. As the recording material P, LTR-sized Vitality (manufactured by Xerox Corporation) having a basis weight of 75 g/m² was used. The printing operation of the image forming apparatus 50 was performed in an environment where the temperature is 23° C. and the humidity is 50%. In addition, the temperature of the heater 113 was controlled to reach 200° C.

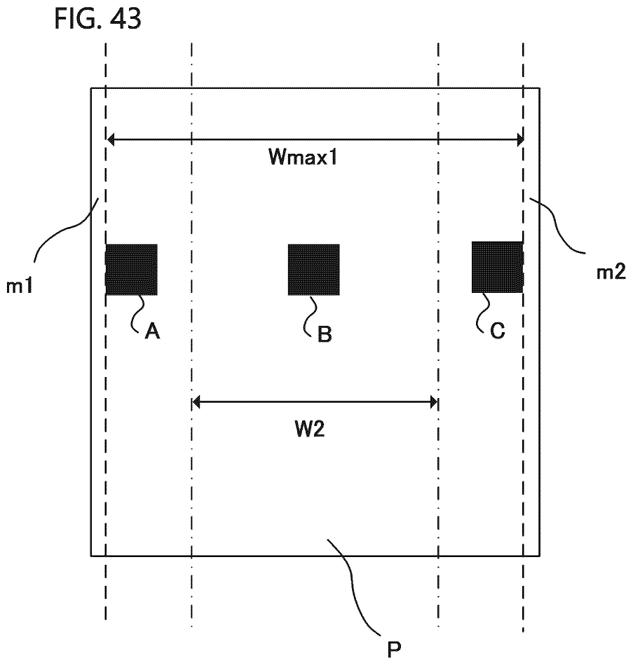

FIG. 43 shows an evaluation image pattern. Solid black image patches are disposed at three places so as to be arranged in the longitudinal direction on the recording material P (patch A, patch B, and patch C). The patch A and the patch C are disposed inside of the maximum image region Wmax1 in the longitudinal direction and outside of the region of the central portion W2 of the recording material P in the longitudinal direction. The patch B is disposed in the region of the central portion W2. This evaluation image was printed on LTR-sized paper, and the fixing state in each solid image of the patch A, the patch B, and the patch C was confirmed. As a result, the most favorable image was obtained in the method for disposing the sliding sheet 114 of the present example. That is, it is possible to efficiently transmit heat from the heater 113 to the fixing film 112 by disposing the sliding sheets 114 outside of the maximum image width in the fixing nip N.

As described above, according to the present example, in the fixing apparatus having the sliding sheet, it is possible to secure the slidability of the fixing film while favorably maintaining the rise properties of the fixing apparatus.

### Example 12

Example 12 has a characteristic in the use of a lubricant. Other configurations are the same as in Example 11 and will thus not be described in detail.

In Example 11, the sliding sheets 114 were disposed outside of the maximum image width in the longitudinal direction of the fixing nip N, whereby the slidability of the fixing film 112 was secured without causing the deterioration of the rise properties or the toner fixing performance to the recording material. However, depending on the configuration of the image forming apparatus or the fixing apparatus, there are cases where the slidability of the fixing film cannot be sufficiently secured in the configuration of Example 11. For example, depending on the material or surface properties of the inner circumferential surface of the fixing film 112, there are cases where the friction force with the heater 113 becomes high and the slidability of the fixing film cannot be secured. In addition, even in a case where the service life of the fixing apparatus is long and the lubrication performance of the lubricant has deteriorated in the second half of the service life, there are cases where the slidability of the fixing film 112 cannot be secured.

Therefore, in the present example, the slidability of the fixing film 112 is improved without causing the deterioration of the rise properties or the toner fixing performance to the recording material by increasing the amount of the lubricant that is applied to the heater 113 even under conditions where the slidability of the fixing film 112 becomes poor.

Lubricant

A configuration in which the amount of the lubricant that is applied to the heater 113 is increased under conditions where the slidability of the fixing film 112 becomes poor, which is a characteristic of the present example, will be described. In the fixing apparatus of the present example, the pressurizing region width in the longitudinal direction of the pressurizing roller 110 on the heater sliding surface S is 220 mm. In addition, 300 mg of grease, which was the lubricant, was spray-applied across 210 mm, which was slightly shorter than the pressurizing region width of 220 mm. The service life of the fixing apparatus in the present example is assumed to be 120,000 times of paper feeding. That is, the service life becomes 20% longer than 100,000 times in Example 11. Therefore, with the grease application amount of 250 mg in Example 11, the lubricity of the lubricant deteriorates in the second half of the service life, and the slidability of the fixing film 112 deteriorates. Therefore, in the present example, the slidability of the fixing film 112 is secured in the terminal stage of the service life by increasing the grease application amount to 300 mg. As described above, in a case where the grease application amount has been increased, depending on the configuration of the fixing apparatus, there are cases where the grease leaks from the end portion of the heater 113. In the present example, the sliding sheets 114 are disposed outside of the grease application region on the heater 113, whereby the leakage of the grease from the end portion of the heater 113 is suppressed.

Effect

In the present example, the sliding sheets 114 are disposed outside of the maximum image width in the longitudinal direction of the fixing nip N, and, furthermore, the amount of the grease that is applied to the heater 113 is increased. This makes it possible to satisfy both the slidability and fixing performance of the fixing film 112.

In order to describe the effect of the present example, comparison is made with the case where the grease application amount is set to 250 mg, which is the configuration of Example 11. In addition, as Comparative Example 3, comparison was also made with the configuration where the sliding sheet 114 is not disposed. Comparative Example 3 is the same configuration as the present example except that the sliding sheet 114 is not disposed, and the grease application amount is also set to 300 mg.

Evaluation conditions will be described. As the recording material P, LTR-sized Vitality (manufactured by Xerox Corporation) having a basis weight of 75 g/m² was used. The printing operation of the image forming apparatus 50 was performed in an environment where the temperature is 23° C. and the humidity is 50%. In addition, the temperature of the heater 113 was controlled to reach 200° C. Under these conditions, 120,000 times of the printing operation was performed with the configuration of each of the present example, Example 11, and Comparative Example 3, and whether or not favorable printing could be performed was confirmed.

Evaluation results will be described. With the configuration of the present example, even after 120,000 times of the printing operation, the slidability of the fixing film 112 did not deteriorate, and favorable printing was performed. On the other hand, with the configuration of Example 11, favorable printing was performed until 100,000 times of printing, but a conveyance defect (so-called jamming) of the recording material P was caused after 110,000 times of printing. This is attributed to the fact that the sliding performance of a sliding agent deteriorated, which made the slidability of the fixing film 112 deteriorate. When the slidability of the fixing film 112 deteriorates, it becomes impossible to normally convey the recording material P in the fixing nip N. In addition, in Comparative Example 3, a conveyance defect of the recording material P was caused after 110,000 times of printing. At this time, in the fixing apparatus in Comparative Example 3, the leakage of the grease at the end portion in the longitudinal direction of the heater 113 was confirmed. In Comparative Example 3, the grease began to leak in the middle of the evaluation, which made the slidability of the fixing film 112 deteriorate and caused the conveyance defect of the recording material P.

As described above, the slidability of the fixing film can be secured without causing the deterioration of the rise properties or the toner fixing performance to the recording material of the fixing apparatus by increasing the amount of the lubricant that is applied to the heater 113 in response to the increase in the assumed service life of the fixing apparatus.

### Example 13

In the present example, the configuration of the sliding sheet 114 is different from that in Example 12. The same portions as in Example 12 will not be described.

In Example 12, the slidability of the fixing film 112 was improved without causing the deterioration of the rise properties or the toner fixing performance to the recording material by increasing the amount of the lubricant that was applied to the heater 113 even under conditions where the slidability of the fixing film 112 became poor. As described above, in Example 12, the sliding sheets 114 are disposed outside of the grease application region on the heater 113, whereby the leakage of the grease from the end portion of the heater 113 is suppressed.

However, in a case where the service life of the fixing apparatus became longer than that of the configuration of Example 12, there were cases where a printing defect was caused in the terminal stage of the service life of the fixing apparatus even when the grease application amount was increased as in Example 2. In addition, since there is a limitation on the amount of grease leakage suppressed by the sliding sheet 114, when the grease amount is further increased than in the configuration of Example 12, there are cases where the grease leaks from the end portion of the heater 113.

Sliding Sheet

In the present example, the sliding sheet 114 is impregnated with silicon oil as an oil repellent. As described above, as the grease which is the lubricant in the present example, a grease obtained by mixing a polytetrafluoroethylene (PTFE) powder as a thickener with perfluoropolyether (PFPE) oil used as base oil is used. Therefore, it is possible to suppress the leakage of the grease applied to the heater 113 from the end portion of the heater 113 by impregnating the sliding sheet 114 with an oil repellent exhibiting oil repellency to the base oil of the grease. In the present example, silicon oil was used as the oil repellent, but the oil repellent is not limited thereto. The same effect can be obtained as long as oil repellents exhibit oil repellency to the grease, which is the lubricant.

The service life of the fixing apparatus in the present example is assumed to be 150,000 times of paper feeding, and the service life becomes longer than 120,000 times, which is the configuration of Example 12. Therefore, with the grease application amount of 300 mg in Example 12, the lubricity of the lubricant deteriorates in the second half of the service life, and the slidability of the fixing film 112 deteriorates. Therefore, in the present example, the slidability of the fixing film 112 can be secured in the terminal stage of the service life by increasing the grease application amount to 375 mg.

Effect

In the present example, the amount of the lubricant that is applied to the heater 113 can be increased by impregnating the sliding sheet 114 with silicon oil as the oil repellent. This satisfies both the slidability and fixing performance of the fixing film 112, which is a characteristic of the present example.

In order to describe the effect of the present example, comparison is made with the case where the grease application amount is set to 300 mg, which is the configuration of Example 12. In addition, as Comparative Example 4, comparison is made with a case where only the grease application amount is increased to 375 mg from the configuration of Example 12.

Evaluation conditions are the same as those in Example 12. Under these conditions, 150,000 times of the printing operation was performed using the configuration of each of the present example, Example 12, and Comparative Example 4, and whether favorable printing could be performed was confirmed.

Evaluation results will be described. With the configuration of the present example, even after 150,000 times of the printing operation, the slidability of the fixing film 112 did not deteriorate, and favorable printing was performed. On the other hand, with the configuration of Example 12, favorable printing was performed until 120,000 times of printing, but a conveyance defect of the recording material P was caused after 130,000 times of printing. This is attributed to the fact that the sliding performance of a sliding agent deteriorated, which made the slidability of the fixing film 112 deteriorate. Next, in Comparative Example 4, a conveyance defect of the recording material P was caused after 130,000 times of printing. At this time, in the fixing apparatus in Comparative Example 4, the leakage of the grease at the end portion in the longitudinal direction of the heater 113 was confirmed. In Comparative Example 4, a grease leakage in the middle of the evaluation made the slidability of the fixing film 112 deteriorate and caused the conveyance defect of the recording material P.

As described above, in the present example, in the fixing apparatus having the sliding sheet, the amount of the lubricant that is applied to the heater 113 can be increased by impregnating the sliding sheet 114 with silicon oil as the oil repellent. This makes it possible to satisfy both the slidability and fixing performance of the fixing film 112. As a result, it is possible to secure the slidability of the fixing film until the final stage of the service life of the fixing apparatus without causing a grease leakage or the deterioration of the slidability.

The configurations of the above-described examples can be arbitrarily combined together to an extent that the configurations are not contradictory to each other. For example, a fixing apparatus may be configured to include the sandwiching configuration of the sliding sheet described in (I) and the openings in the sliding sheet described in (II). In addition, a fixing apparatus may be configured to include the sandwiching configuration of the sliding sheet described in (I) and the disposition of the sliding sheet as described in (III).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-170440, filed on Oct. 25, 2022, which is hereby incorporated by reference wherein in its entirety.

What is claimed is:

1. A fixing apparatus comprising:
a first rotation member;
an elongated heater configured to have a heat generating member and a substrate on which the heat generating member is provided and to be disposed in an internal space of the first rotation member;
a heater holder configured to hold the heater;
a stay configured to support the heater holder;
a sliding sheet configured to be disposed between the heater and the first rotation member and to slide on an inner circumferential surface of the rotating first rotation member; and
a second rotation member configured to form a nip portion with the heater through the first rotation member, and
in the nip portion, a toner image formed on a recording material being heated and fixed,
wherein, when a longitudinal direction of a surface of the substrate on which the heat generating member is provided, a transverse direction that is orthogonal to the longitudinal direction, and a thickness direction that is orthogonal to the longitudinal direction and the transverse direction are designated, the heater holder has a first side configured to hold the heater and a second side opposite to the first side in the thickness direction, and
the sliding sheet is sandwiched by the second side and the stay.

2. The fixing apparatus according to claim 1, wherein the heater holder has mounting portions configured to fix both end portions of the sliding sheet in a sliding direction of the sliding sheet and the first rotation member, and
the sliding sheet is pressurized and sandwiched between the stay and the heater holder at positions closer to the nip portion than the mounting portions on a circumference of the sliding sheet in the sliding direction.

3. The fixing apparatus according to claim 2, wherein the sliding sheet has opening portions at the both end portions in the sliding direction,
the mounting portions of the heater holder are convex portions that correspond to the both end portions of the sliding sheet, respectively, and
the convex portions of the heater holder are inserted into the opening portions of the sliding sheet, whereby the sliding sheet is fixed.

4. The fixing apparatus according to claim 3, wherein the opening portions of the sliding sheet and the convex portions of the heater holder are provided at a plurality of places along the longitudinal direction of the first rotation member, respectively.

5. The fixing apparatus according to claim 4, wherein the stay pressurizes portions to be pressurized of the heater holder with a substantially uniform pressure along the longitudinal direction.

6. The fixing apparatus according to claim 5, wherein the stay is capable of relieving the pressure against the portions to be pressurized.

7. The fixing apparatus according to claim 5, wherein a step portion is formed in the portion to be pressurized of the heater holder.

8. The fixing apparatus according to claim 1, wherein the heater holder has a protrusion portion that is provided upstream of the heater in a conveyance direction of the recording material and protrudes toward the second rotation member more than a surface of the heater that comes into contact with the sliding sheet.

9. The fixing apparatus according to claim 1, wherein the sliding sheet is disposed between the heater and the first rotation member at a position where the heater that is held on the heater holder faces the first rotation member and is disposed between the heater holder and the first rotation member at a position where the heater holder faces the first rotation member.

10. The fixing apparatus according to claim 1, wherein the sliding sheet is disposed between the heater holder and the heater at a position where the heater that is held on the heater holder faces the first rotation member and is disposed between the heater holder and the first rotation member at a position where the heater holder faces the first rotation member.

11. The fixing apparatus according to claim 2, wherein the mounting portions are provided on at least any of an upstream side and a downstream side in the sliding direction.

12. The fixing apparatus according to claim 2, wherein the sliding sheet is wound around and fixed to the heater holder on an upstream side or a downstream side in the sliding direction.

13. The fixing apparatus according to claim 1, wherein the first rotation member is a tubular film, and
the second rotation member is a pressurizing roller.

14. A fixing apparatus comprising:
a first rotation member;
a heater configured to be disposed in an inner space of the first rotation member;
a second rotation member;
a nip-forming member configured to form a nip portion with the second rotation member through the first rotation member;
a stay configured to support the nip-forming member; and
a sliding sheet configured to be disposed between the nip-forming member and the first rotation member and to slide on an inner circumferential surface of the rotating first rotation member,
wherein, in the nip portion, a toner image formed on a recording material is heated and fixed,
the nip-forming member has a first side configured to form the nip portion and a second side opposite to the first side, and
the sliding sheet is sandwiched by the second side and the stay.

15. The fixing apparatus according to claim 1, wherein the sliding sheet that is sandwiched between the heater and the first rotation member in a region corresponding to the nip portion has a first region and a second region,
the first region is a region corresponding to a region in the nip portion through which the recording material passes, and the second region is a region corresponding to a region in the nip portion through which the recording material does not pass.

16. The fixing apparatus according to claim 1, wherein the sliding sheet is sandwiched between the heater and the first rotation member in a region corresponding to the nip portion, and
the sliding sheet is provided outside of a maximum image-forming region in a longitudinal direction of a surface of the substrate on which the heat generating member is provided.
